(19) United States
(12) Patent Application Publication
(10) Pub. No.: US 2015/0271527 A1
(43) Pub. Date: Sep. 24, 2015

(54) VIDEO ENCODING METHOD AND APPARATUS, VIDEO DECODING METHOD AND APPARATUS, AND PROGRAMS THEREFOR

(71) Applicant: NIPPON TELEGRAPH AND TELEPHONE CORPORATION, Tokyo (JP)

(72) Inventors: Shiori Sugimoto, Yokosuka-shi (JP); Shinya Shimizu, Yokosuka-shi (JP); Hideaki Kimata, Yokosuka-shi (JP); Akira Kojima, Yokosuka-shi (JP)

(73) Assignee: NIPPON TELEGRAPH AND TELEPHONE CORPORATION, Tokyo (JP)

(21) Appl. No.: 14/428,306

(22) PCT Filed: Sep. 20, 2013
(86) PCT No.: PCT/JP2013/075482

§ 371 Date: Mar. 13, 2015

(30) Foreign Application Priority Data
Sep. 25, 2012 (JP) 2012-211156

(51) Int. Cl. H04N 19/82; H04N 19/503; H04N 19/105; H04N 19/597; H04N 19/167; H04N 19/182; H04N 19/117; H04N 19/33; G06T 7/00

(52) U.S. Cl. CPC H04N 19/82; H04N 19/33; H04N 19/503; H04N 19/105; G06T 7/0071; H04N 19/167; H04N 19/182; H04N 19/117; H04N 19/597; G06T 2207/10016

(57) ABSTRACT

When decoding code data of a video wherein each frame that forms the video is divided into a plurality of processing regions, each processing region is subjected to predictive decoding, a provisional decoded image obtained by provisional image decoding utilizing a low-resolution prediction residual is generated, and a final decoded image is generated by updating decoded values of the provisional decoded image. Additionally, when dividing each frame that forms a video into a plurality of processing regions and subjecting each processing region to predictive encoding in which a high-resolution prediction residual is subjected to downsampling to generate a low-resolution prediction residual, a subsampled prediction residual is generated by a subsampling process which subjects only part of pixels of the high-resolution prediction residual to sampling, and the subsampled prediction residual is determined to be the low-resolution prediction residual.

### TECHNICAL FIELD

The present invention relates to a video encoding method, a video decoding method, a video encoding apparatus, a video decoding apparatus, a video encoding program, and a video decoding program.

Priority is claimed on Japanese Patent Application No. 2012-211156, filed Sep. 25, 2012, the contents of which are incorporated herein by reference.

### BACKGROUND ART

In general video encoding, spatial and temporal continuity of each object is utilized to divide each video frame into blocks as units to be processed. A video signal of each block is spatial or temporal predicted, and prediction information, that indicates the utilized prediction method, and a prediction residual are encoded, which considerably improves the encoding efficiency in comparison with a case of encoding the video signal itself.

A method called “RRU (Reduced Resolution Update)” further improves the encoding efficiency by reducing the resolution of at least part of the prediction residual before transformation and quantization of the prediction residual (see, for example, Non-Patent Document 1). Since the prediction is performed on a high-resolution basis and the prediction residual having a low resolution is subjected to an upsampling process during decoding thereof, a final image has a high resolution.

Although objective (image) quality is degraded by such a process, the bit rate is eventually improved due to an increase in the number of encoding target bits. In addition, influence on subjective (image) quality is not strong in comparison with the influence on the objective quality.

The above-described function is supported by a standard called “ITU-T H.263”, and it is known that this function is particularly effective when a heavily dynamic region is present in a target sequence. This is because an RRU mode makes it possible to secure a high frame rate of the encoder and a preferable resolution and quality of a region (e.g., a dynamic region) having a small variance in the prediction residual.

However, the quality of such a region (e.g., dynamic region) having a small variance in the prediction residual is considerably affected by an accuracy for the upsampling of the prediction residual. Therefore, it is preferable and effective to have a method and an apparatus for RRU video encoding and decoding, which solve such a problem.

Below, free viewpoint video encoding will be explained. In the free viewpoint video encoding, a target scene is imaged from a plurality of positions and at a plurality of angles by means of multiple imaging devices so as to obtain ray information about the scene. The ray information is utilized to reproduce ray information pertaining to any viewpoint, and thereby video (images) observed from said viewpoint are generated.

Such ray information for a scene is represented in one of various data forms. One of most popular forms utilizes video and a depth image called a “depth map” for each of frames that form the video (see, for example, Non-Patent Document 2).

In the depth map, distance (i.e., depth) from the relevant camera to each object is described for each pixel, which implements simple representation of three-dimensional information about the object. When observing a single object from two cameras, each depth value of the object is proportional to the reciprocal of disparity between the cameras. Therefore, the depth map may be called a “disparity map (or disparity image)”.

On the other hand, camera video image corresponding to the depth map may be called a “texture”. Since one value is assigned to each pixel in the depth map representation, the depth map can be regarded as a gray scale image.

In addition, similar to a video signal, depth map video images (below, “depth map” is applied to either of a simple image and a video image), which are temporally continued depth maps, have spatial and temporal correlation due to the spatial and temporal continuity of each object.

Therefore, a video encoding method utilized to encode an ordinary video signal can efficiently encode a depth map by removing spatial and temporal redundancy.

Generally, the texture and the depth map have strong correlation with each other. Therefore, in order to encode both the texture and depth map (as performed in the free viewpoint video encoding), the encoding efficiency can be further improved utilizing such correlation between the texture and depth map.

Non-Patent Document 3 disclose a method of removing redundancy by commonly utilizing prediction information (about block division, motion vectors, and reference frames) for encoding both the texture and depth map, and thereby efficient encoding is implemented.

### PRIOR ART DOCUMENT

### Non-Patent Document

Non-Patent Document 1: A. M. Tourapis, J. Boyce, “Reduced Resolution Update Mode for Advanced Video Coding”, ITU-T Q6/SG16, document VCEG-V05, Munich, March 2004.
Non-Patent Document 2: Y. Mori, N. Fukusima, T. Fuji, and M. Tanimoto, “View Generation with 3D Warping Using Depth Information for FTV”, In Proceedings of 3DTV-CON2008, pp. 229-232, May 2008.
Non-Patent Document 3: I. Daribo, C. Tillier, and B. P. Popescu, “Motion Vector Sharing and Bitrate Allocation for 3D Video-Plus-Depth Coding,” EURASIP Journal on Advances in Signal Processing, vol. 2009, Article ID 258920, 13 pages, 2009.

### DISCLOSURE OF INVENTION

### Problem to be Solved by the Invention

Conventional RRU processes the prediction residual of each block without using information from any part outside the relevant block. Each prediction residual having a low resolution is computed from a high-resolution prediction residual utilizing downsampling interpolation (e.g., two-dimensional bilinear interpolation) based on relative positions of relevant samples. In order to obtain a decoded block, the relevant low-resolution prediction residual is encoded, reconstructed, and subjected to upsampling interpolation so that the residual is restored as a high-resolution prediction residual, which is added to a predicted image.

FIGS. 15A and 15B are diagrams that each show a spatial arrangement between high-resolution prediction residual samples and low-resolution prediction residual samples in conventional RRU and an example computation for the upsampling interpolation.

In each of the figures, white circles show the arrangement of the high-resolution prediction residual samples, and shaded circles show the arrangement of the low-resolution prediction residual samples. Additionally, characters “a” to “e” and “A” to “D” in some circles shows examples of the pixel value. Specifically, how each of the pixel values “a” to “e” of high-resolution prediction residual samples is computed utilizing the pixel values “A” to “D” of peripheral low-resolution prediction residual samples is shown in the relevant figure.

In a block that includes samples whose residual values considerably differ from each other, the accuracy of a residual reconstructed utilizing the relevant upsampling interpolation is degraded, which degrades the quality of the decoded image. In addition, generally, boundary parts in a block are subjected to upsampling which utilizes only samples in the block, that is, does not utilize any samples in the other blocks. Therefore, a block distortion (uniquely generated in the vicinity of such block boundaries) may be generated at block boundary parts, depending on the accuracy of the interpolation.

In order to prevent such degradation in the quality or distortion, it may be effective to improve an interpolation filter utilized in the upsampling interpolation for the residual. However, it is generally difficult to perfectly restore residual information lost through the downsampling interpolation.

In light of the above circumstances, an object of the present invention is to provide a video encoding method, a video decoding method, a video encoding apparatus, a video decoding apparatus, a video encoding program, and a video decoding program, by which degradation in quality or block distortion of the decoded image due to the upsampling for the prediction residual in RRU can be prevented and a finally obtained decoded image for every relevant resolution can have a desired quality.

### Means for Solving the Problem

The present invention provides a video decoding method utilized when decoding code data of a video, wherein each frame that forms the video is divided into a plurality of processing regions, each processing region is subjected to predictive decoding, and the method comprises:

a provisional decoding step that generates a provisional decoded image obtained by provisional image decoding utilizing a low-resolution prediction residual; and

a decoded image generation step that generates a final decoded image by updating decoded values of the provisional decoded image.

In a preferable example, a sampling and interpolation step is further provided, which generates an interpolated prediction residual by means of an interpolation process which executes sampling and interpolation utilizing pixels for which the low-resolution prediction residual was computed (or set). The provisional decoding step generates the provisional decoded image based on the interpolated prediction residual.

In such a case, the sampling and interpolation step may execute the interpolation process with reference to auxiliary information that correlates with the video.

In addition, the decoded image generation step may generate the final decoded image with reference to auxiliary information that correlates with the video.

In another preferable example, the video decoding method further comprises:

a residual associated pixel determination step that determines a positional relationship between each pixel of the low-resolution prediction residual and a corresponding pixel of the provisional decoded image, wherein:

the provisional decoding step generates the provisional decoded image by performing decoding of original pixels of the provisional decoded image, which correspond to the pixels of the low-resolution prediction residual, based on the positional relationship; and

the decoded image generation step generates the final decoded image using the decoded values of the pixels of the provisional decoded image, which correspond to the pixels of the low-resolution prediction residual, so as to update the decoded values of the other pixels in the provisional decoded image.

In this case, the residual associated pixel determination step may determine a predetermined relationship to be the positional relationship.

Additionally, the residual associated pixel determination step may adaptively determine the positional relationship.

In such a case, the residual associated pixel determination step may adaptively determine the positional relationship with reference to auxiliary information that correlates with the video.

In addition, the decoded image generation step may generate the final decoded image by further referring to auxiliary information that correlates with the video.

It is also possible that the video decoding method further comprises:

a sampling and interpolation step that generates an interpolated prediction residual by means of an interpolation process which executes sampling and interpolation utilizing pixels for which the low-resolution prediction residual was computed, wherein:

the provisional decoding step generates the provisional decoded image by performing:

the decoding of the original pixels of the provisional decoded image, which correspond to the pixels of the low-resolution prediction residual, based on the positional relationship, and

decoding of the other original pixels of the provisional decoded image, which do not correspond to the pixels of the low-resolution prediction residual, based on the interpolated prediction residual; and

the decoded image generation step generates the final decoded image using the decoded values of the pixels of the provisional decoded image, which correspond to the pixels of the low-resolution prediction residual, so as to update the decoded values of the other pixels in the provisional decoded image.

In such a case, the residual associated pixel determination step may determine a predetermined relationship to be the positional relationship.

Additionally, the residual associated pixel determination step may adaptively determine the positional relationship.

In this case, the residual associated pixel determination step may adaptively determine the positional relationship with reference to auxiliary information that correlates with the video.

In addition, the decoded image generation step may generate the final decoded image by further referring to auxiliary information that correlates with the video.

In a typical example, the auxiliary information is a predicted image for the video.

In another typical example, the auxiliary information is part of components of a signal that forms the video.

In another typical example, the auxiliary information is an auxiliary video that correlates with the video.

In such a case, the auxiliary video may be another video that captures a scene identical to that captured by the above video.

Additionally, when the video is a video from a viewpoint among a multi-viewpoint video, the auxiliary video is a video from another viewpoint.

In addition, the auxiliary video may be a depth map that corresponds to the above video.

Furthermore, when the video is a depth map, the auxiliary video may be a texture that corresponds to the depth map.

In another typical example, the auxiliary information is an auxiliary video predicted image generated from an auxiliary video, that correlates with the above video, based on prediction information for this video; and

the method further comprises an auxiliary video predicted image generation step that generates the auxiliary video predicted image from the auxiliary video, based on the prediction information for the video.

In such a case, it is possible that:

the auxiliary information is an auxiliary video prediction residual generated from the auxiliary video and the auxiliary video predicted image; and

the method further comprises an auxiliary video prediction residual generation step that generates the auxiliary video prediction residual from the auxiliary video and the auxiliary video predicted image.

In another typical example, a demultiplexing step that demultiplexes the code data into auxiliary information code data and video code data; and

an auxiliary information decoding step that decodes the auxiliary information code data to generate the auxiliary information

The present invention also provides a video encoding method utilized when dividing each frame that forms a video into a plurality of processing regions and subjecting each processing region to predictive encoding in which a high-resolution prediction residual is subjected to downsampling to generate a low-resolution prediction residual, the method comprising:

a subsampling step that generates a subsampled prediction residual by means of a subsampling process which subjects only part of pixels of the high-resolution prediction residual to sampling; and

a residual downsampling step that determines the subsampled prediction residual to be the low-resolution prediction residual.

In a preferable example, in the subsampling step, positions of the pixels subjected to the sampling are predetermined.

In another preferable example, the subsampling step adaptively determines the pixels subjected to the sampling.

In this case, the subsampling step may adaptively determine the pixels subjected to the sampling with reference to auxiliary information that correlates with the video.

In another preferable example, the video encoding method further comprises:

a sampling and interpolation step that generates an interpolated prediction residual by means of an interpolation process which executes sampling and interpolation for the pixels of the high-resolution prediction residual,

wherein the residual downsampling step generates the low-resolution prediction residual from the subsampled prediction residual and the interpolated prediction residual.

In such a case, the residual downsampling step may generate the low-resolution prediction residual by applying the subsampled prediction residual to predetermined positions of the low-resolution prediction residual and applying the interpolated prediction residual to the other positions of the low-resolution prediction residual.

In addition, the residual downsampling step may generate the low-resolution prediction residual from the subsampled prediction residual and the interpolated prediction residual with reference to auxiliary information that correlates with the video.

In a typical example, the auxiliary information is a predicted image for the video.

In another typical example, the auxiliary information is part of components of a signal that forms the video.

In another typical example, the auxiliary information is an auxiliary video that correlates with the video.

In this case, the auxiliary video may be another video that captures a scene identical to that captured by the above video.

Additionally, when the video is a video from a viewpoint among a multi-viewpoint video, the auxiliary video may be a video from another viewpoint.

In addition, the auxiliary video may be a depth map that corresponds to the above video.

Furthermore, when the video is a depth map, the auxiliary video may be a texture that corresponds to the depth map.

In another typical example, the auxiliary information is an auxiliary video predicted image generated from an auxiliary video, that correlates with the above video, based on prediction information for this video; and

the method further comprises an auxiliary video predicted image generation step that generates the auxiliary video predicted image from the auxiliary video, based on the prediction information for the video.

In such a case, it is possible that the auxiliary information is an auxiliary video prediction residual generated from the auxiliary video and the auxiliary video predicted image; and

the method further comprises an auxiliary video prediction residual generation step that generates the auxiliary video prediction residual from the auxiliary video and the auxiliary video predicted image.

In another typical example, the video encoding method further comprises:

an auxiliary information encoding step that encodes the auxiliary information to generate auxiliary information code data; and

a multiplexing step that generates code data in which the auxiliary information code data is multiplexed with video code data.

The present invention also provides a video decoding apparatus utilized when decoding code data of a video, wherein each frame that forms the video is divided into a plurality of processing regions, each processing region is subjected to predictive decoding, and the apparatus comprises:

a provisional decoding device that generates a provisional decoded image obtained by provisional image decoding utilizing a low-resolution prediction residual; and

a decoded image generation device that generates a final decoded image by updating decoded values of the provisional decoded image.

The present invention also provides a video encoding apparatus utilized when dividing each frame that forms a video into a plurality of processing regions and subjecting each processing region to predictive encoding in which a high-resolution prediction residual is subjected to downsampling to generate a low-resolution prediction residual, the apparatus comprising:

a subsampling device that generates a subsampled prediction residual by means of a subsampling process which subjects only part of pixels of the high-resolution prediction residual to sampling; and

a residual downsampling device that determines the subsampled prediction residual to the low-resolution prediction residual.

The present invention also provides a video decoding program by which a computer executes the steps in the video decoding method.

The present invention also provides a video encoding program by which a computer executes the steps in the video encoding method.

The present invention also provides a computer-readable storage medium which stores a video decoding program by which a computer executes the steps in the video decoding method.

The present invention also provides a computer-readable storage medium which stores a video encoding program by which a computer executes the steps in the video encoding method.

### Effect of the Invention

In accordance with the present invention, degradation in quality or block distortion of the decoded image due to the upsampling for the prediction residual in RRU can be prevented and a final decoded image for every relevant resolution can have a desired quality.

### BRIEF DESCRIPTION OF THE DRAWINGS

FIG. 1 is a block diagram that shows the structure of a video encoding apparatus 100 according to a first embodiment of the present invention.

FIG. 2 is a flowchart that shows the operation of the video encoding apparatus 100 of FIG. 1.

FIG. 3 is a block diagram that shows the structure of a video decoding apparatus 200 according to the first embodiment.

FIG. 4 is a flowchart that shows the operation of the video decoding apparatus 200 of FIG. 3.

FIG. 5 is a block diagram that shows the structure of a video encoding apparatus 100a according to a second embodiment of the present invention.

FIG. 6 is a flowchart that shows the operation of the video encoding apparatus 100a of FIG. 5.

FIG. 7 is a block diagram that shows the structure of a video decoding apparatus 200a according to the second embodiment.

FIG. 8 is a flowchart that shows the operation of the video decoding apparatus 200a of FIG. 7.

FIG. 9 is a block diagram that shows the structure of a video encoding apparatus 100b according to a third embodiment of the present invention.

FIG. 10 is a flowchart that shows the operation of the video encoding apparatus 100b of FIG. 9.

FIG. 11 is a block diagram that shows the structure of a video decoding apparatus 200b according to the third embodiment.

FIG. 12 is a flowchart that shows the operation of the video decoding apparatus 200b of FIG. 11.

FIG. 13 is a block diagram that shows an example of a hardware configuration of the video encoding apparatus formed using a computer and a software program.

FIG. 14 is a block diagram that shows an example of a hardware configuration of the video decoding apparatus formed using a computer and a software program.

FIG. 15A is a diagram that shows a spatial arrangement between high-resolution prediction residual samples and low-resolution prediction residual samples in conventional RRU and an example computation for the upsampling interpolation.

FIG. 15B is a diagram that shows a spatial arrangement between high-resolution prediction residual samples and low-resolution prediction residual samples in conventional RRU and another example computation for the upsampling interpolation.

### MODE FOR CARRYING OUT THE INVENTION

### First Embodiment

Below, a video encoding apparatus and a video decoding apparatus in accordance with a first embodiment of the present invention will be explained with reference to the drawings.

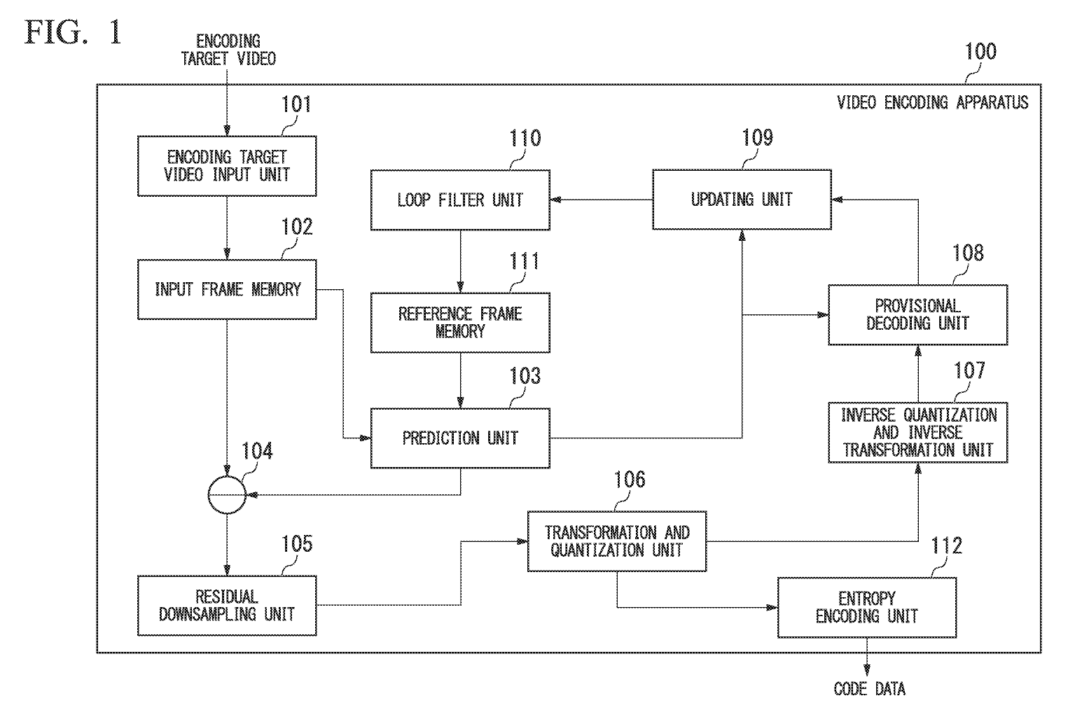

First, the video encoding apparatus will be explained. FIG. 1 is a block diagram that shows the structure of the video encoding apparatus according to the present embodiment.

As shown in FIG. 1, the video encoding apparatus 100 has an encoding target video input unit 101, an input frame memory 102, a prediction unit 103, a subtraction unit 104, a residual downsampling unit 105, a transformation and quantization unit 106, an inverse quantization and inverse transformation unit 107, a provisional decoding unit 108, an updating unit 109, a loop filter unit 110, a reference frame memory 111, and an entropy encoding unit 112.

The encoding target video input unit 101 is utilized to input a video (image) as an encoding target into the video encoding apparatus 100. Below, this video as an encoding target is called an “encoding target video”. In particular, a frame to be processed is called an “encoding target frame” or an “encoding target image”.

The input frame memory 102 stores the input encoding target video.

The prediction unit 103 subjects the encoding target image stored in the input frame memory 102 to a prediction process so as to generate a high-resolution predicted image.

The subtraction unit 104 computes a difference between the encoding target image stored in the input frame memory 102 and the high-resolution predicted image generated by the prediction unit 103 so as to generate a high-resolution prediction residual.

The residual downsampling unit 105 subjects the generated high-resolution prediction residual to downsampling so as to generate a low-resolution prediction residual.

The transformation and quantization unit 106 subjects the generated low-resolution prediction residual to relevant transformation and quantization, so as to generate quantized data.

The inverse quantization and inverse transformation unit 107 subjects the generated quantized data to corresponding inverse quantization and inverse transformation, so as to generate a decoded low-resolution prediction residual.

The provisional decoding unit 108 generates a provisional decoded image utilizing the high-resolution predicted image output from the prediction unit 103 and the decoded low-resolution prediction residual output from the inverse quantization and inverse transformation unit 107.

The updating unit 109 performs updating of the provisional decoded image so as to generate a high-resolution decoded image.

The loop filter unit 110 multiplies the generated high-resolution decoded image (decoded frame) by a loop filter so as to generate a reference frame.

The reference frame memory 111 stores the reference frame generated by the loop filter unit 110.

The entropy encoding unit 112 subjects the quantized data and relevant prediction information to entropy encoding so as to generate and output code data (or encoded data).

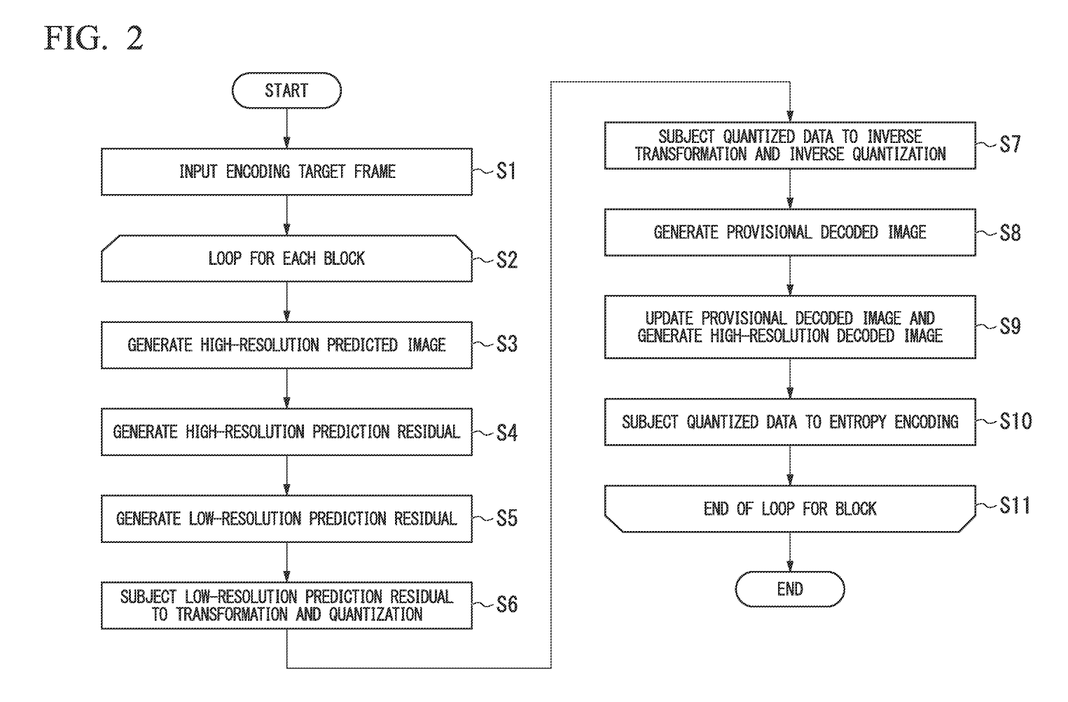

Next, in FIG. 2, the operation of the video encoding apparatus 100 of FIG. 1 will be explained. FIG. 2 is a flowchart that shows the operation of the video encoding apparatus 100 of FIG. 1.

Here, a process of encoding a frame in the encoding target video will be explained. The entire video (moving image) can be encoded by repeating the relevant process for each frame.

First, the encoding target video input unit 101 makes an encoding target frame input into the video encoding apparatus 100 and stores the frame in the input frame memory 102 (see step S1). Here, some frames in the encoding target video have been previously encoded and decoded frames thereof are stored in the reference frame memory 111.

After the video input, the encoding target frame is divided into encoding target blocks and each block is subjected to a routine of encoding a video signal of the encoding target frame (see step S2). That is, the following steps S3 to S10 are repeatedly executed until all blocks of the relevant frame have been processed sequentially.

In the operation repeated for each block, first, the prediction unit 103 performs a prediction process utilizing the encoding target frame and the reference frame so as to generate a predicted image (see step S3). Below, the predicted image is called a “high-resolution predicted image” for purpose of distinction.

It is possible to employ any prediction method by which the relevant decoding apparatus can accurately generate a high-resolution predicted image by utilizing prediction information or the like. In ordinary video encoding, a prediction method such as intra-picture prediction or motion compensation is employed. Generally, prediction information utilized in such a method is encoded and multiplexed with video code data. However, if the prediction can be performed without using specific prediction information, such multiplexing can be omitted.

Next, the subtraction unit 104 computes a difference between the high-resolution predicted image and the encoding target image so as to generate a prediction residual (see step S4). Below, the prediction residual is called a “high-resolution prediction residual” for purpose of distinction.

When the high-resolution prediction residual generation is completed, the residual downsampling unit 105 executes the downsampling of the high-resolution prediction residual, so as to generate a low-resolution prediction residual (see step S5). The downsampling may be performed utilizing any method.

Here, a downsampling method and a corresponding decoded image updating method will be explained, which solves a problem of the known RRU, that is, loss (in the relevant information) due to an averaging of the residual values.

For simple explanation, when “1/n” downsampling is performed in both the vertical and horizontal directions, a group of n×n pixels of the relevant high-resolution residual is subjected to a certain process so as to obtain one pixel of the corresponding low resolution residual.

Generally, the RRU has an interpolated value obtained by any downsampling interpolation which may compute an average of residual values in the relevant group. In decoding, the interpolated value is subjected to nxn upsampling interpolation, and obtained values are utilized as residual values of the individual pixels so as to generate a high-resolution residual. A decoded image is obtained by adding the high-resolution residual to the relevant predicted image.

In this case, each group of pixels, for which prediction is generally accurate, has a small variance in the residual values and thus is not considerably influenced by the use of the interpolated value.

In contrast, each group of pixels, for which prediction is partially inaccurate, has a large variance in the residual values and the use of the interpolated value produces an overall error.

For this problem, the low-resolution prediction residual may be generated utilizing a subsampling process by which values at specific positions in the high-resolution prediction residual are secured. In this case, in provisional decoding (explained later), an accurate decoded image can be obtained at each specific position. Accordingly, the accurate decoded pixels at the specific positions may be referred to for updating the decoded values of peripheral decoded pixels. The updating method will be explained later in detail.

The positions of subsampled pixels (where the prediction residual is secured) may be predetermined, or they may be appropriately determined if the positions can be identified in the corresponding decoding.

For example, a predetermined position such as a left-upper or right-lower position in n×n pixels may be subjected to the subsampling, or the groups of n×n pixels may have different positions for the subsampling.

In another example, in each set of n×n pixels, only a pixel which is most inaccurately predicted (i.e., has the maximum residual) is subjected to the subsampling. In this case, in the corresponding decoding, a position having the maximum residual may be estimated, or the subsampling position may be determined utilizing such a method and another method (described later) which are combined.

Additionally, the positions of subsampled pixels may be determined with reference to the high-resolution predicted image or other information.

More specifically, the high-resolution predicted image is referred to for estimating an area where the residual is relatively large within each processing (target) region, and the positions of subsampled pixels may be determined focusing on the area. In this case, it may be assumed that the residual is relatively large at an outline portion in the predicted image, and an area in the vicinity of the outline portion may be subjected to the subsampling. Another estimating method may be employed.

It may also be assumed that each area having a large variance in the residual has a large loss (in the relevant information) if the density of the positions of subsampled pixels is low. In this case, an area having a large residual may be estimated and the positions of subsampled pixels may be determined so that the density of the positions is high at the estimated position.

Further in this case, the relevant area may be estimated based on the characteristics of the predicted image, as described above. In another example, in each processing region, a specific number of predetermined positions are subjected to the subsampling, and after that, a variance in the subsampled residual values is computed to determine additional positions of subsampled pixels so that subsampling is further performed with a higher density (of the positions of subsampled pixels) in an area whose variance is determined to be large.

The above-described methods may be appropriately combined with each other.

For example, a predetermined number of positions in the vicinity of an outline portion in the predicted image is subjected to the subsampling, and after that, a variance in the subsampled residual values is computed. Additional positions of subsampled pixels may be determined so that subsampling is further performed with a higher density (of the positions of subsampled pixels) in an area whose variance is determined to be large.

In addition, the positions of subsampled pixels may be encoded and included in code data, a pattern for the positions of subsampled pixels may be predetermined for each processing region, and identification information for such a pattern may be encoded and included in code data.

In another method, for pixels at certain positions, the low-resolution prediction residual is generated by subjecting the residual values of the corresponding high-resolution prediction residual to subsampling, and for pixels at the other positions, the low-resolution prediction residual is generated by means of interpolation utilizing a plurality of residual values (a set of residual values) of the high-resolution prediction residual.

Here, when the residual values of all pixels in the relevant set are less than or equal to a certain threshold, interpolation may be performed utilizing the residual values of the pixels in the set so as to generate the low-resolution prediction residual. In this case, if the residual values of the low-resolution prediction residual are less than or equal to the threshold in the decoding procedure, the residual at this threshold may be applied to all pixels in the relevant set in the decoding.

In addition, the provisional decoding and the decoded image updating may be performed by any method and will be explained later in detail.

Then the transformation and quantization unit 106 subjects the low-resolution prediction residual to the transformation and quantization so as to generate quantized data (see step S6). This transformation and quantization may be executed in any method by which the decoding apparatus can obtain accurate results of corresponding inverse transformation and inverse quantization.

When the transformation and quantization is completed, the inverse quantization and inverse transformation unit 107 subjects the quantized data to the inverse quantization and inverse transformation so as to generate a decoded low-resolution prediction residual (see step S7).

Next, the provisional decoding unit 108 generates a provisional decoded image utilizing the high-resolution predicted image generated in step S3 and the decoded low-resolution prediction residual generated in step S7 (see step S8).

The provisional decoded image may be generated utilizing any method.

For example, it may be generated by adding (value of) each pixel for the decoded low-resolution prediction residual and (value of) the corresponding pixel in the high-resolution predicted image to each other. In this case, one-to-one correspondence or one-to-many correspondence may be employed.

In an example, the residual values generated by the subsampling of the high-resolution prediction residual may correspond to the pixels at the positions of subsampled pixels in a one-to-one-relationship and may also correspond to other pixels in the same group. In an example, the residual values generated by the interpolation utilizing the high-resolution prediction residual may correspond to all pixels utilized in the interpolation. Any other correspondence may be employed.

The present process can also be applied to a case which employs two or more correspondences together.

For example, among the pixels of the low-resolution prediction residual, residual values of some pixels may be determined utilizing the subsampling, and residual values of some other pixels may be determined utilizing the interpolation, as described above.

In addition, such a correspondence may be provided as a predetermined correspondence or may be determined with reference to the high-resolution predicted image or other information as described above. In another example, the correspondence may be determined based on encoded information which indicates the correspondence.

Additionally, in the generated provisional decoded image, the provisional decoded value of each provisional decoded pixel which has no corresponding pixel of the low-resolution prediction residual may be determined utilizing a predicted value or generated by means of interpolation utilizing provisional decoded values of pixels which correspond to the low-resolution prediction residual, where it is possible to define no specific provisional decoded values.

In another example, the provisional decoded image may be generated by generating the high-resolution prediction residual by means of upsampling interpolation utilizing the low-resolution prediction residual and adding the high-resolution prediction residual to the high-resolution predicted image.

The provisional decoding may be performed utilizing only part of pixels of the low-resolution prediction residual. For example, only pixels, to which residual values utilizing the subsampling are applied, are decoded, and in the decoded image updating, all remaining pixels are subjected to the updating with reference to residual values obtained by the interpolation.

Next, after the provisional decoding has been completed, the updating unit 109 performs updating of the provisional decoded values of the provisional decoded image so as to generate a high-resolution decoded image. The loop filter unit 110 then multiplies the generated image by a loop filter and stores the product as a block of the reference frame in the reference frame memory 111 (see step S9). The updating may be executing utilizing any method.

Here, an updating method will be explained, which is employed when the downsampling was performed by means of the subsampling of the relevant prediction residual values and the obtained residual was encoded, where accurate decoded values were acquired for part of the pixels in the provisional decoding. Here, the pixels for which accurate decoded values were acquired in the provisional decoding are called “previously-decoded pixels”, and such pixels are not subjected to the updating. In addition, the pixels other than the previously-decoded pixels are called “provisional decoded pixels”.

In a most simple method, decoded values of the provisional decoded pixels are determined by means of simple interpolation utilizing the previously-decoded pixels.

In another example, the interpolated values obtained utilizing the previously-decoded pixels are defined to be first provisional decoded values, values obtained by adding interpolated values for the residual values of the provisional decoded pixels (i.e., decoded low-resolution prediction residual) to the relevant predicted values of the provisional decoded pixels are defined to be second provisional decoded values, and the first and second provisional decoded values are compared so as to select the more likely one of both.

Such selection may be performed utilizing any method. For example, the first provisional decoded values are selected in a part where noise is produced, which is familiar as a loss due to an averaging of the residuals.

The above selection may be performed utilizing the high-resolution predicted image or other information.

Various types of methods, which determine most reasonable decoded values of the provisional decoded pixels with reference to the high-resolution predicted image, may be employed.

For example, when difference between the residual values of adjacent previously-decoded pixels is large, a considerably large loss due to averaging is anticipated if the decoded values are determined utilizing interpolation for the residual or the decoded values. In such a case, predicted value distances (i.e., difference between predicted values) between each provisional decoded pixel and the adjacent previously-decoded pixels are compared, and the decoded value of the provisional decoded pixel may be determined based on the residual or decoded value of an adjacent previously-decoded pixel by which a shorter predicted value distance (i.e., smaller difference) is obtained.

In another example, the relevant decoded values may be determined utilizing weighting in accordance with the predicted value distance. In addition, the relevant estimation may be performed in a wider range in comparison with the adjacent state.

Additionally, when in the downsampling, the positions of subsampled pixels are adaptively determined with reference to the high-resolution predicted image, if the sampling density is high at an outline portion of the high-resolution predicted image or the like, the updating may be performed utilizing any above-described method or another method with reference to peripheral previously-decoded pixels, where in a portion having a low sampling density, the updating may be performed with reference to representative peripheral previously-decoded pixels. The representative peripheral previously-decoded pixels may be pixels at predetermined positions or may be adaptively determined.

For example, a previously-decoded pixel having the shortest distance to a target provisional decoded pixel to be updated may be referred to, or a provisional decoded pixel to be referred to may be determined based on the value of each provisional decoded pixel. Any of other various updating method may be employed in accordance with an employed method of determining the positions of subsampled pixels.

In addition, when part of prediction residual values is subjected to subsampling and another part of the prediction residual values is subjected to interpolation in the downsampling and then encoding is performed, if the provisional decoded value of each provisional decoded pixel to be updated is obtained based on the residual of the interpolation and the previously-decoded pixels are obtained based on the residual of the subsampling, then the provisional decoded value may be compared with each value obtained utilizing any above-described method or another method with reference to peripheral previously-decoded pixels, so as to select a most reasonable value.

Any of various other updating methods may be employed in accordance with a combination of the subsampling and the interpolation.

In the above-described examples, the relevant estimation is performed utilizing predicted values, residual values, previously-decoded values, or the like. However, any values which are included in the video code data and can be referred to may be utilized.

For example, when the prediction is performed employing motion compensation or disparity compensation, a motion vector or a disparity vector may be utilized. If the RRU method is applied to a luminance component of YCbCr, decoding may be performed with reference to a color difference component, and a reverse relationship thereof is also possible.

Although examples of the decoded image updating methods have been explained above, the individual methods are not limited to the examples, and any other methods may also be employed.

The multiplication utilizing the loop filter may not be performed if it is not necessary. However, in general video encoding, encoding noises are removed utilizing a deblocking filter or another filter. For this purpose, a filter utilized to remove degraded information due to RRU may be employed. In addition, such a loop filter may be adaptively generated similar to or in parallel with the decoded image updating.

Next, the entropy encoding unit 112 subjects the quantized data to entropy encoding so as to generate code data (see step S10). If necessary, prediction information or other additional information may also be encoded and included in code data.

After all blocks are processed (see step S11), the code data is output.

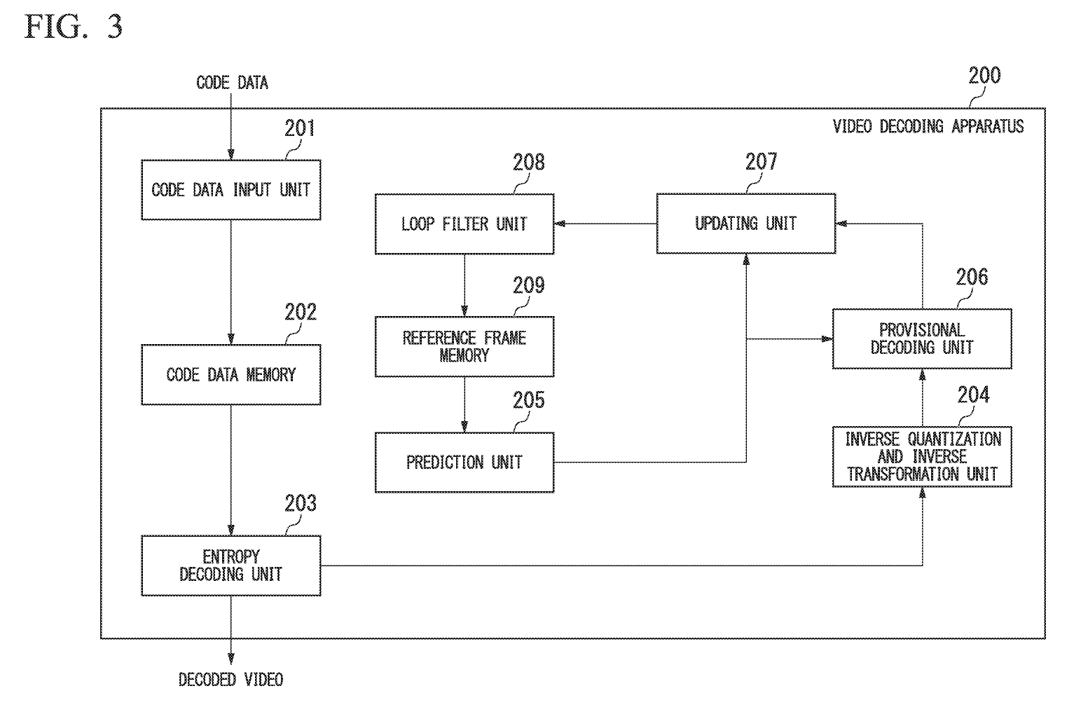

Below, a video decoding apparatus will be explained. FIG. 3 is a block diagram that shows the structure of the video decoding apparatus according to the first embodiment of the present invention.

As shown in FIG. 3, the video decoding apparatus 200 has a code data input unit 201, a code data memory 202, an entropy decoding unit 203, an inverse quantization and inverse transformation unit 204, a prediction unit 205, a provisional decoding unit 206, an updating unit 207, a loop filter unit 208, and a reference frame memory 209.

The code data input unit 201 is utilized to input video code data as a decoding target into the video decoding apparatus 200. Below, this video code data as a decoding target is called a “decoding target video code data”. In particular, a frame to be processed is called a “decoding target frame” or a “decoding target image”.

The code data memory 202 stores the input decoding target video code data.

The entropy decoding unit 203 subjects the code data of the decoding target frame to entropy decoding so as to generate quantized data.

The inverse quantization and inverse transformation unit 204 subjects the relevant quantized data to relevant inverse quantization and inverse transformation so as to generate a decoded low-resolution prediction residual.

The prediction unit 205 subjects the decoding target image to a prediction process so as to generate a high-resolution predicted image.

The provisional decoding unit 206 generates a provisional decoded image by adding the decoded low-resolution prediction residual generated by the inverse quantization and inverse transformation unit 204 to the high-resolution predicted image generated by the prediction unit 205.

In the above process, if the positions of subsampled pixels have been adaptively determined as described above, the corresponding positions (in the high-resolution image) of the low-resolution prediction residual may also be determined utilizing a similar method.

The updating unit 207 performs updating of undecoded pixels of the provisional decoded image utilizing the high-resolution predicted image output from the prediction unit 205 (also utilizing the decoded low-resolution prediction residual in some methods) so as to generate a high-resolution decoded image.

The loop filter unit 208 multiplies the generated decoded frame (i.e., high-resolution decoded image) by a loop filter so as to generate a reference frame.

The reference frame memory 209 stores the generated reference frame.

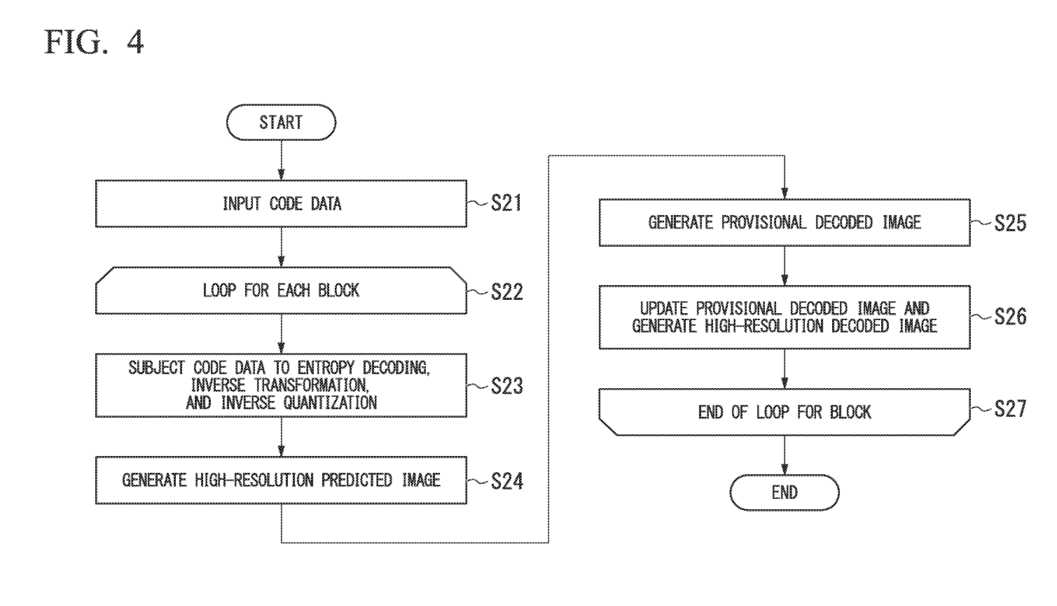

Next, referring to FIG. 4, the operation of the video decoding apparatus 200 of FIG. 3 will be explained. FIG. 4 is a flowchart that shows the operation of the video decoding apparatus 200 of FIG. 3.

Here, a process of decoding a frame in the code data will be explained. The entire video is decoded by repeating the relevant process for each frame.

First, the code data input unit 201 receives code data and stores the data in the code data memory 202 (see step S21). Here, some frames in the decoding target video have been previously decoded and are stored in the reference frame memory 209.

Next, the decoding target frame is divided into target blocks and each block is subjected to a routine of decoding a video signal of the decoding target frame (see step S22). That is, the following steps S23 to S27 are repeatedly executed until all blocks of the relevant frame have been processed sequentially.

In the operation repeated for each block, first, the entropy decoding unit 203 subjects the code data to entropy decoding, and the inverse quantization and inverse transformation unit 204 subjects the relevant result to the inverse quantization and inverse transformation so as to generate a decoded low-resolution prediction residual (see step S23).

If prediction information or other additional information is included in the code data, such information may also be decoded so as to appropriately generate required information.

Next, the prediction unit 205 performs a prediction process utilizing the decoding target frame and a reference block (or reference frame) so as to generate a high-resolution predicted image (see step S24).

In ordinary video encoding, a prediction method such as intra-picture prediction or motion compensation is employed and prediction information utilized in such a method is multiplexed with video code data. However, if the prediction can be performed without using specific prediction information, such prediction information can be cancelled.

Next, the provisional decoding unit 206 generates a provisional decoded image by adding the high-resolution predicted image generated in step S24 and corresponding pixels of the decoded low-resolution prediction residual generated in step S23 to each other (see step S25).

If the code data of the decoding target has been produced through the adaptive determination of the positions of subsampled pixels, such adaptive determination of the positions of subsampled pixels may also be executed here.

Next, after the provisional decoding has been completed, the updating unit 207 performs updating of the provisional decoded pixels of the provisional decoded image utilizing the provisional decoded image and the high-resolution predicted image (also utilizing the decoded low-resolution prediction residual in some methods), so as to generate the high-resolution decoded image. The loop filter unit 208 then multiplies the generated high-resolution decoded image by a loop filter and stores the product as a reference block in the reference frame memory 209 (see step S26).

Although the provisional decoding and updating each may be executing utilizing any method, if the employed method corresponds to the downsampling method employed in the relevant video encoding apparatus, a higher decoding performance can be obtained.

The downsampling method and the decoded image updating method corresponding thereto can be performed as described above.

The multiplication utilizing the loop filter may not be performed if it is not necessary. However, in general video encoding, encoding noises are removed utilizing a deblocking filter or another filter. For this purpose, a filter utilized to remove degraded information due to RRU may be employed. In addition, such a loop filter may be adaptively generated similar to or in parallel with the decoded image updating.

Lastly, when all blocks have been processed (see step S27), the result thereof is output as a decoded frame.

In the operations shown in FIGS. 2 and 4, the execution order of the steps may be modified.

### Second Embodiment

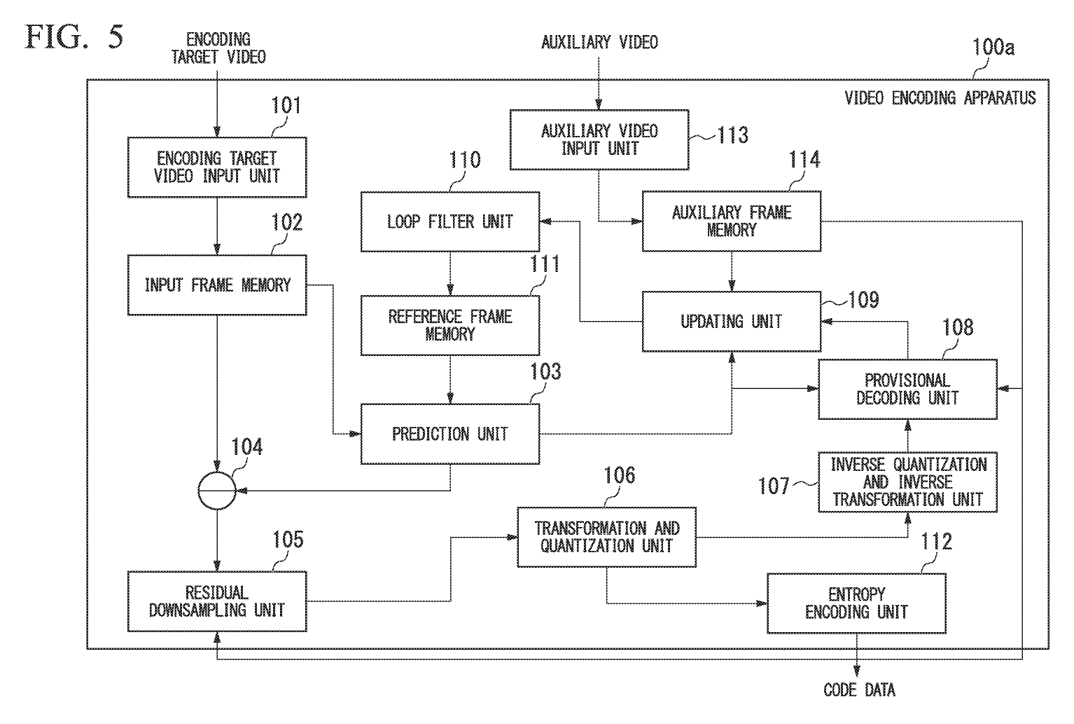

Next, a video encoding apparatus and a video decoding apparatus according to a second embodiment of the present invention will be explained. FIG. 5 is a block diagram that shows the structure of a video encoding apparatus 100a according to the second embodiment of the present invention. In FIG. 5, parts identical to those in FIG. 1 are given identical reference numerals and explanations thereof are omitted here.

In comparison with the apparatus of FIG. 1, the apparatus of FIG. 5 has distinctive features of further providing an auxiliary video input unit 113 and an auxiliary frame memory 114.

The auxiliary video input unit 113 is provided to input reference video, which is utilized in the decoded image updating, into the video encoding apparatus 100a. Below, this reference video is called “auxiliary video”. In particular, a frame to be processed is called an “auxiliary frame” or an “auxiliary image”.

The auxiliary frame memory 114 stores the input auxiliary video.

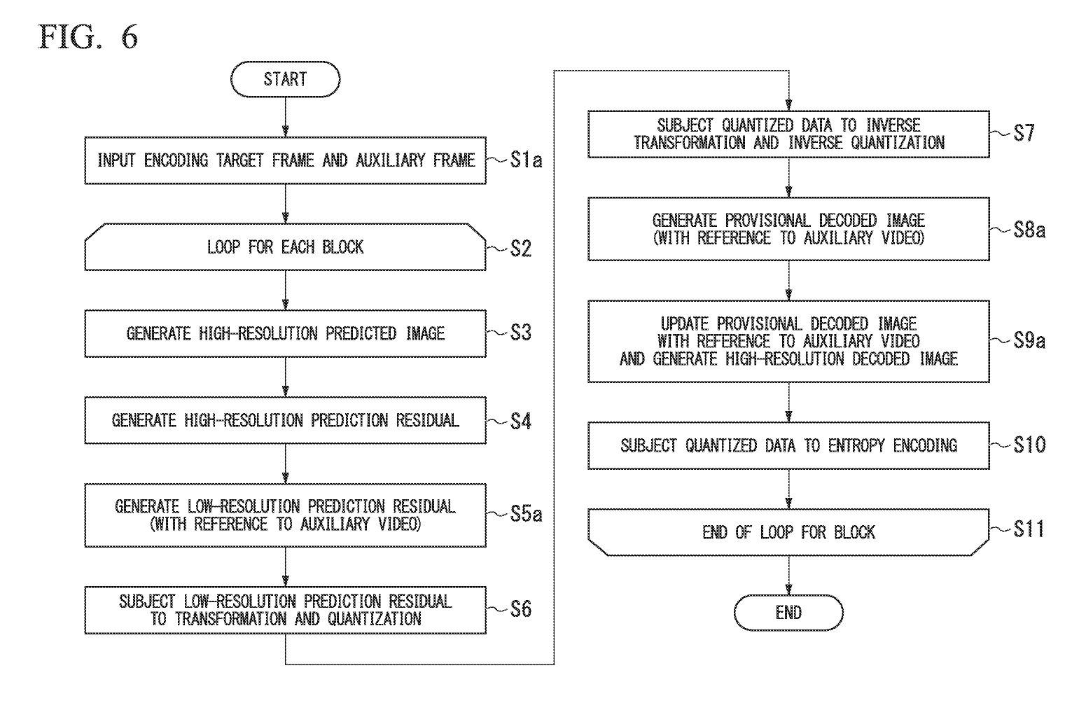

Next, referring to FIG. 6, the operation of the video encoding apparatus 100a shown in the figure will be explained. FIG. 6 is a flowchart that shows the operation of the video encoding apparatus 100a of FIG. 5.

FIG. 6 shows an operation in which auxiliary video, that has a correlation with the encoding target video, is input from an external device and is utilized in the decoded image updating. In FIG. 6, steps identical to those in FIG. 2 are given identical step numbers and explanations thereof are omitted here.

First, the encoding target video input unit 101 makes an encoding target frame input into the video encoding apparatus 100a and stores the frame in the input frame memory 102. In parallel to this process, the auxiliary video input unit 113 inputs an auxiliary video frame into the video encoding apparatus 100a and stores the frame in the auxiliary frame memory 114 (see step S1a).

Here, some frames in the encoding target video have been previously encoded and decoded frames thereof are stored in the reference frame memory 114, where corresponding auxiliary video are stored in the auxiliary frame memory 114.

Here, although input encoding target frames are encoded sequentially in the present explanation, the input order does not need to always coincide with the encoding order. When the input order does not coincide with the encoding order, a previously-input frame is stored in the input frame memory 102 until the frame to be encoded next is input.

When the encoding target frame stored in the input frame memory 102 has been processed by an encoding method explained later, this frame may be deleted in the input frame memory 102. However, the auxiliary video frame stored in the auxiliary frame memory 114 may be stored until a decoded frame of the corresponding encoding target frame is deleted in the reference frame memory 111.

The auxiliary video input in the above step S1a may be any video which is correlated with the encoding target video.

For example, when the encoding target video is a video from a viewpoint among a multi-viewpoint video, the auxiliary video may be a video from another viewpoint.

In another example, if there is a depth map corresponding to the encoding target video, the depth map may function as the auxiliary video. If the encoding target video is provided as a depth map (i.e., information having a depth-map form), a corresponding texture may function as the auxiliary video.

Additionally, the auxiliary video input in step S1a may differ from auxiliary video obtained in the relevant decoding apparatus. However, when utilizing the same video as the auxiliary video obtained in the relevant decoding apparatus, the decoding quality can be improved.

For example, if the auxiliary video is encoded and contained in code data together with the relevant video, auxiliary video which has been encoded and then decoded may be employed so as to prevent a decoding error due to encoding noise for the auxiliary video.

Other examples of the auxiliary video obtained in the decoding apparatus include a video of a frame that is identical to the encoding target frame and is synthesized utilizing motion-compensated prediction or the like, based on a decoded video from a previously-encoded video which has a viewpoint other than that of the encoding target frame and corresponds to a frame different from the encoding target frame.

Said other examples also include (i) a depth map that corresponds to the encoding target video and is synthesized utilizing virtual viewpoint synthesis or the like, based on a decoded depth map from a previously-encoded depth map that corresponds to a video having a viewpoint other than that of the encoding target frame, and (ii) a depth map estimated by means of stereo matching or the like utilizing information decoded from a set of previously-encoded images having viewpoints other than that of the encoding target video.

Here, steps S2 to S4 are executed in a manner similar to the corresponding steps in the flowchart of FIG. 2.

When the high-resolution prediction residual generation is completed, the residual downsampling unit 105 executes the downsampling of the high-resolution prediction residual, so as to generate a low-resolution prediction residual (see step S5a). The downsampling may be performed utilizing any method, and a method similar to that employed in the first embodiment may be utilized.

For example, pixels at predetermined positions may be subjected to subsampling. Here, when adaptively performing the downsampling with reference to the auxiliary video, a higher decoding performance can be obtained.

In an example, the positions of subsampled pixels may be determined with reference to corresponding auxiliary video by an image, block, or pixel unit.

In another example, the auxiliary video is subjected to image processing such as binarization, edge extraction, region segmentation, or the like, so as to estimate a boundary portion of each subject or another region where the residual is concentrated. Then among the pixels of the high-resolution prediction residual, pixels in the estimated region of the relevant auxiliary video are subjected to the subsampling, and thereby loss due to an averaging of the residual values (i.e., problem in the known RRU) is prevented.

Such estimation may be performed utilizing an ordinary method pertaining to the image processing, or a simple comparison between adjacent pixel values. Any other method may also be employed.

In addition, information about, for example, parameters utilized in the binarization may be encoded and included in the relevant code data. In this case, optimization of the parameters may be performed so as to obtain the highest restoration efficiency. Furthermore, a predicted image may also be utilized to estimate the region where the residual is concentrated.

For example, a region estimated utilizing auxiliary video and a region estimated utilizing a predicted image may be added and determined to be the region where the residual is concentrated. Any other method may also be employed.

In such a case, the decoded image updating may also be performed by any method. That is, a method with reference to the auxiliary video (explained later) may be employed, or a method with reference to no auxiliary video may also be employed where a simple linear interpolation may be executed instead.

The above-described examples are just examples and any other methods can be employed.

Then the transformation and quantization unit 106 subjects the low-resolution prediction residual to the transformation and quantization so as to generate quantized data (see step S6). This transformation and quantization may be executed in any method by which the decoding apparatus can obtain accurate results of corresponding inverse transformation and inverse quantization.

When the transformation and quantization is completed, the inverse quantization and inverse transformation unit 107 subjects the quantized data to the inverse quantization and inverse transformation so as to generate a decoded low-resolution prediction residual (see step S7).

Next, the provisional decoding unit 108 generates a provisional decoded image by adding the high-resolution predicted image to corresponding pixels of the decoded low-resolution prediction residual (see step S8a).

If the positions of subsampled pixels have been determined utilizing the auxiliary video as described above, the corresponding positions (of the low-resolution prediction residual) in the high-resolution image may also be determined with reference to the auxiliary video.

Next, after the provisional decoding has been completed, the updating unit 109 performs updating of undecoded pixels of the provisional decoded image utilizing the provisional decoded image and the auxiliary video so as to generate a high-resolution decoded image. The loop filter unit 110 then multiplies the generated image by a loop filter and stores the product as a reference frame in the reference frame memory 111 (see step S9a).

Here, an updating method will be explained, which is employed when the downsampling was performed by means of the subsampling of the relevant prediction residual values and the obtained residual was encoded, where accurate decoded values were acquired for part of the pixels in the provisional decoding. Here, the pixels for which accurate decoded values were acquired in the provisional decoding are called “previously-decoded pixels”, and such pixels are not subjected to the updating. In addition, the pixels other than the previously-decoded pixels are called “provisional decoded pixels”.

Especially in the second embodiment, an updating method with reference to pixels or a region, which corresponds to the auxiliary video, will be explained. Here, similar to the first embodiment, the following may also be referred to: (i) predicted values of peripheral pixels (which include the present pixel) and (ii) residual values and decoded values of previously-decoded pixels in a set of pixels which includes the present pixel or a set of peripheral pixels.

As the updating method, a method as described in the first embodiment may be performed utilizing auxiliary video.

In another method, the auxiliary video is subjected to a certain region division, and in each region of the decoded image, which corresponds to each divided region, interpolation of the residual or decoded values is performed. Accordingly, loss (in an outline portion or the like) due to an averaging of the residual values can be prevented.

In particular, if the encoding target video is information having a depth-map format and the corresponding texture is auxiliary video, or in a reverse relationship thereof, then outlines in both videos coincide with each other in most cases. Therefore, the decoding performance may be improved by embedding the residual or decoded values along an outline portion of the auxiliary video.

As another method, the above-described process may be executed utilizing a predicted image, or both methods may be combined.

For example, each region divided utilizing the auxiliary video may further be divided utilizing the predicted image. Such a method may be combined with the above-described downsampling method with reference to the auxiliary video, so as to further improve the restoration performance.

The multiplication utilizing the loop filter may not be performed if it is not necessary. However, in general video encoding, encoding noises are removed utilizing a deblocking filter or another filter. For this purpose, a filter utilized to remove degraded information due to RRU may be employed. In addition, such a loop filter may be adaptively generated similar to or in parallel with the decoded image updating.

Next, the entropy encoding unit 112 subjects the quantized data to entropy encoding so as to generate code data (see step S10). If necessary, prediction information or other additional information may also be encoded and included in code data.

After all blocks are processed (see step S11), the code data is output.

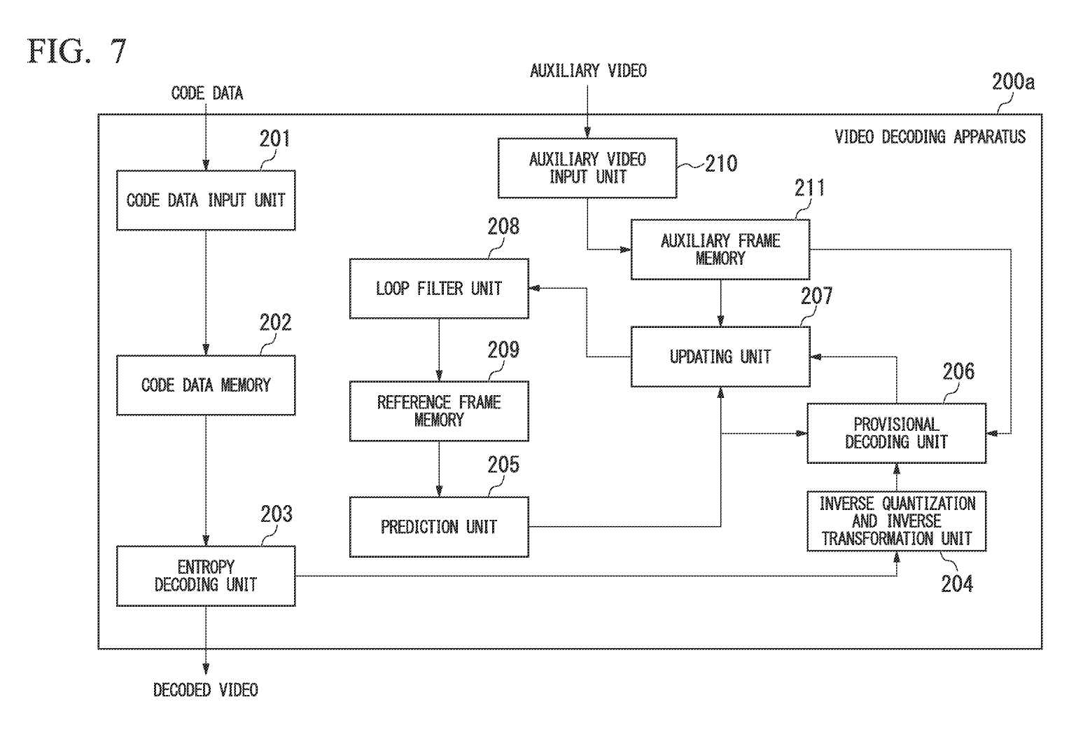

Below, a video decoding apparatus will be explained. FIG. 7 is a block diagram that shows the structure of the video decoding apparatus 200a according to the second embodiment of the present invention. In FIG. 7, parts identical to those in FIG. 3 are given identical reference numerals and explanations thereof are omitted here.

In comparison with the apparatus of FIG. 3, the apparatus of FIG. 7 has distinctive features of further providing an auxiliary video input unit 210 and an auxiliary frame memory 211.

The auxiliary video input unit 210 is provided to input reference video, which is utilized in the decoded image updating, into the video decoding apparatus 200a. The auxiliary frame memory 211 stores the input auxiliary video.

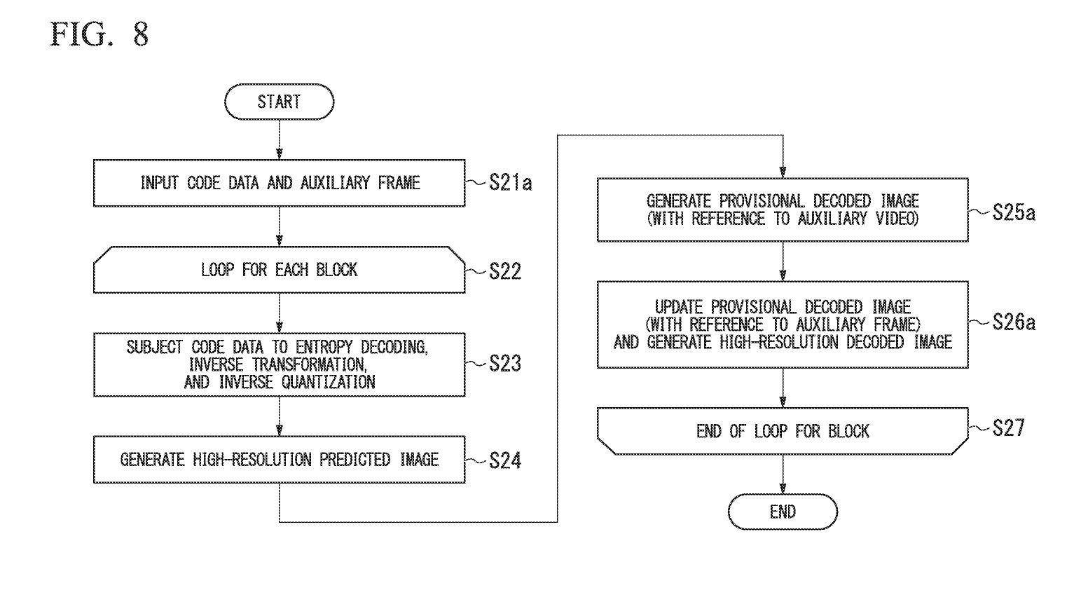

Next, in FIG. 8, the operation of the video decoding apparatus 200a shown in FIG. 7 will be explained. FIG. 8 is a flowchart that shows the operation of the video decoding apparatus 200a of FIG. 7.

FIG. 8 shows an operation in which auxiliary video, that has a correlation with the encoding target video, is input from an external device and is utilized in the decoded image updating. In FIG. 8, steps identical to those in FIG. 4 are given identical step numbers and explanations thereof are omitted here.

First, the code data input unit 201 receives code data and stores the data in the code data memory 202. In parallel to this process, the auxiliary video input unit 210 receives an auxiliary video frame and stores the frame in the auxiliary frame memory 211 (see step S21a). Here, some frames in the decoding target video have been previously decoded and are stored in the reference frame memory 209.

Here, steps S22 to S24 are executed in a manner similar to the corresponding steps in the flowchart of FIG. 4.

Next, the provisional decoding unit 206 generates a provisional decoded image by adding the high-resolution predicted image to corresponding pixels of the decoded low-resolution prediction residual (see step S25a).

If the code data to be decoded has been produced by determining the positions of subsampled pixels utilizing the auxiliary video, the corresponding positions (of the low-resolution prediction residual) in the high-resolution image may also be determined with reference to the auxiliary video.

Next, after the provisional decoding has been completed, the updating unit 207 performs updating of undecoded pixels of the provisional decoded image utilizing the provisional decoded image and the auxiliary video or other information so as to generate a high-resolution decoded image. The loop filter unit 208 then multiplies the generated high-resolution decoded image by a loop filter and stores the product as a reference block in the reference frame memory 209 (see step S26a).

Although the updating may be executing utilizing any method, if the employed method corresponds to the downsampling method employed in the relevant video encoding apparatus, a higher decoding performance can be obtained. The downsampling method and the decoded image updating method corresponding thereto can be performed as described above.

The multiplication utilizing the loop filter may not be performed if it is not necessary. However, in general video encoding, encoding noises are removed utilizing a deblocking filter or another filter. For this purpose, a filter utilized to remove degraded information due to RRU may be employed. In addition, such a loop filter may be adaptively generated similar to or in parallel with the decoded image updating.

Lastly, when all blocks have been processed (see step S27), the result thereof is output as a decoded frame.

In the operations shown in FIGS. 6 and 8, the execution order of the steps may be modified.

### Third Embodiment

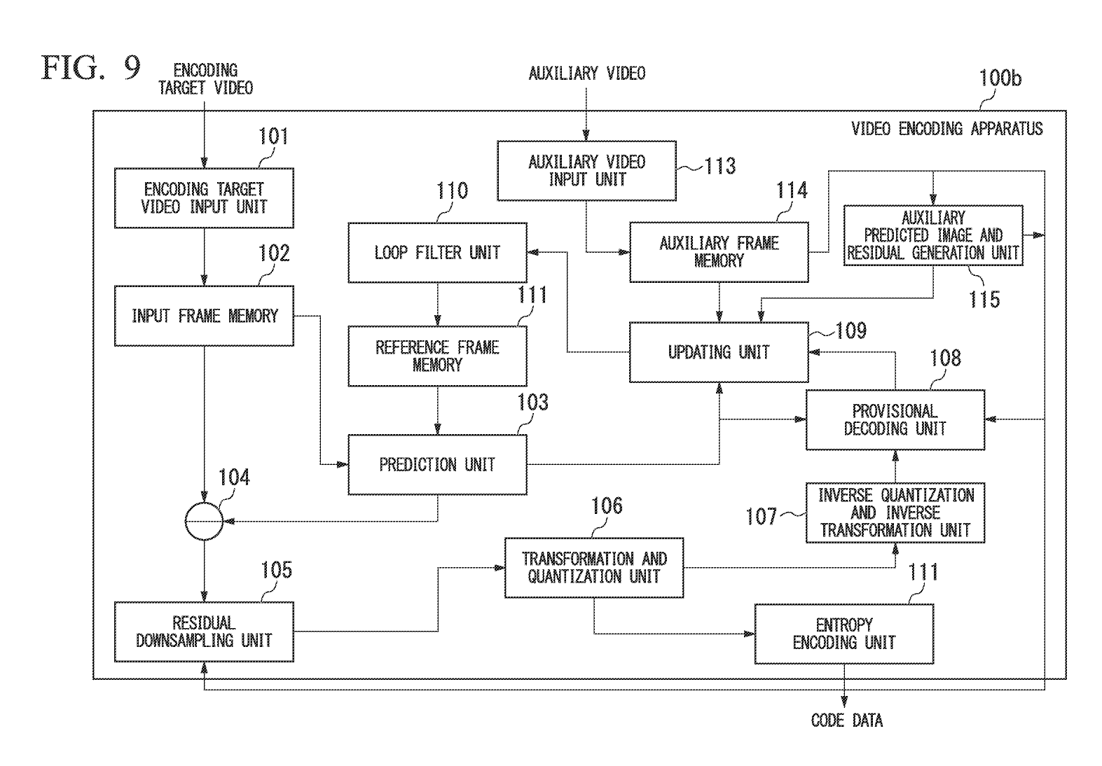

Next, a video encoding apparatus and a video decoding apparatus according to a third embodiment of the present invention will be explained. FIG. 9 is a block diagram that shows the structure of a video encoding apparatus 100b according to the third embodiment of the present invention. In FIG. 9, parts identical to those in FIG. 5 are given identical reference numerals and explanations thereof are omitted here.

In comparison with the apparatus of FIG. 5, the apparatus of FIG. 9 has distinctive features of further providing an auxiliary video predicted image and residual generation unit 115.

The auxiliary video predicted image and residual generation unit 115 generates a predicted image and residual for the auxiliary video, where the generated information is referred to in the decoded image updating. Below, the predicted image and the residual (of the auxiliary video) for reference are respectively called an “auxiliary predicted image” and an “auxiliary prediction residual”.

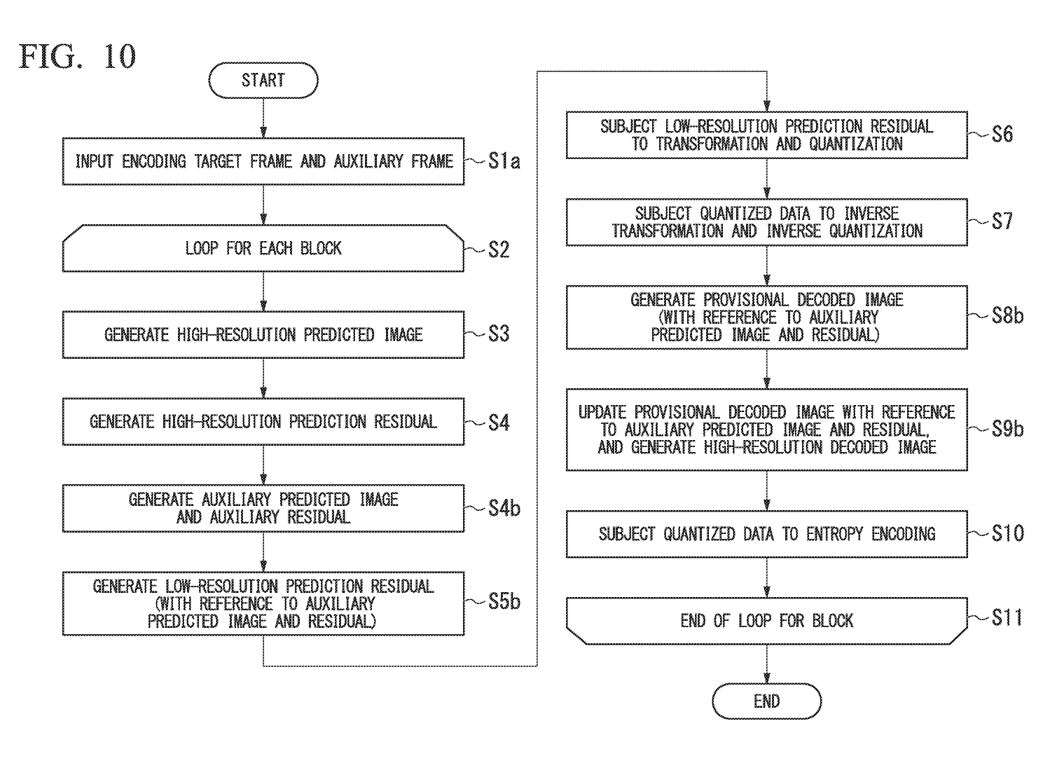

Next, referring to FIG. 10, the operation of the video encoding apparatus 100b shown in FIG. 9 will be explained. FIG. 10 is a flowchart that shows the operation of the video encoding apparatus 100b of FIG. 9.

FIG. 10 shows an operation in which auxiliary video and the predicted image and residual thereof are generated and utilized in the decoded image updating. In FIG. 10, steps identical to those in FIG. 6 are given identical step numbers and explanations thereof are omitted here.

First, steps S1a and S2 are executed in a manner similar to the second embodiment.

The auxiliary video input in the above step S1a may be any video which is correlated with the encoding target video and a predicted image of which can be generated based on prediction information utilized in the prediction of the encoding target video or prediction information that can be estimated utilizing such prediction information.

For example, when the encoding target video is a video from a viewpoint among a multi-viewpoint video, the auxiliary video may be a video from another viewpoint. In this case, in consideration of a transformation such as viewpoint movement, transformation of a predicted vector for the encoding target video may be performed so as to obtain a predicted vector of the auxiliary video. Any other transformation may also be performed.

In another example, if there is a depth map corresponding to the encoding target video, the depth map may function as the auxiliary video. If the encoding target video is provided as a depth map (i.e., information having a depth-map form), a corresponding texture may function as the auxiliary video.

In such a case, the predicted image of the auxiliary video may be generated utilizing prediction information that is identical to the prediction information for the encoding target video.

The following steps S3 to S10 are repeatedly executed until all blocks of the relevant frame have been processed sequentially.

In addition, steps S3 and S4 are executed in a manner similar to that of the second embodiment.

After generating the predicted image and the prediction residual for the encoding target video, the auxiliary video predicted image and residual generation unit 115 generates the auxiliary predicted image and the auxiliary prediction residual, which are a predicted image and a prediction residual for the auxiliary video (see step S4b).

Here, prediction information utilized to generate the auxiliary predicted image may be identical to the prediction information for the encoding target video or may be information obtained by a transformation as described above.

Next, the residual downsampling unit 105 executes the downsampling of the high-resolution prediction residual, so as to generate a low-resolution prediction residual (see step S5b).

The downsampling may be performed with reference to the auxiliary predicted image and the auxiliary prediction residual. For example, the stronger the auxiliary prediction residual of each pixel, the earlier the pixel is subjected to the relevant sampling. In another method, one of predetermined subsampling position patterns is selected, by which as many pixels having strong auxiliary prediction residual as possible are subjected to the relevant sampling.

Then the transformation and quantization unit 106 subjects the low-resolution prediction residual to the transformation and quantization so as to generate quantized data (see step S6). This transformation and quantization may be executed in any method by which the decoding apparatus can obtain accurate results of corresponding inverse transformation and inverse quantization.

When the transformation and quantization is completed, the inverse quantization and inverse transformation unit 107 subjects the quantized data to the inverse quantization and inverse transformation so as to generate a decoded low-resolution prediction residual (see step S7).

Next, the provisional decoding unit 108 generates a provisional decoded image by adding the high-resolution predicted image to corresponding pixels of the decoded low-resolution prediction residual (see step S8b).

If the positions of subsampled pixels have been determined utilizing the auxiliary predicted image and the auxiliary prediction residual as described above, the corresponding positions (of the low-resolution prediction residual) in the high-resolution image may also be determined by a similar method.

Next, after the provisional decoding has been completed, the updating unit 109 performs updating of the provisional decoded image utilizing the provisional decoded image, the auxiliary predicted image, and the auxiliary prediction residual so as to generate a high-resolution decoded image.

The loop filter unit 110 then multiplies the generated image by a loop filter and stores the product as the block of a reference frame in the reference frame memory 111 (see step S9b).

Here, an updating method will be explained, which is employed when the downsampling was performed by means of the subsampling of the relevant prediction residual values and the obtained residual was encoded, where accurate decoded values were acquired for part of the pixels in the provisional decoding. Here, the pixels for which accurate decoded values were acquired in the provisional decoding are called “previously-decoded pixels”, and such pixels are not subjected to the updating. In addition, the pixels other than the previously-decoded pixels are called “provisional decoded pixels”.

As the updating method, a method as described in the first or second embodiment may be performed utilizing the auxiliary predicted image and the auxiliary prediction residual, where some methods may be combined in any manner.

For example, both the auxiliary video and the auxiliary predicted image are subjected to outline extraction or region extraction, so as to estimate the region where the residual is concentrated.

In another method, it is assumed that a local part of the prediction residual of the decoding target image has an intensity distribution corresponding to the intensity of the auxiliary prediction residual, and the intensity distribution of the residual values for the decoded image is estimated utilizing known residual values. According to the estimated distribution, the prediction residual of the provisional decoded pixels is determined. The determined prediction residual is added to the high-resolution predicted image so as to determine the target decoded values.

In another method, the auxiliary prediction residual is subjected to the downsampling utilizing a method similar to that applied to the relevant video, so as to generate a low-resolution auxiliary prediction residual. Similarly, an auxiliary provisional decoded image is generated by means of provisional decoding, and a method and parameters for the method, by which the generated image is most preferably decoded, are determined. The updating of the decoded image for the relevant video is performed utilizing the determined method.

The decoded image updating may be performed by any method selected from among the above-described methods or another method.

Such a method may be combined with the above-described downsampling method with reference to the auxiliary predicted image and the auxiliary prediction residual, so as to further improve the restoration performance.

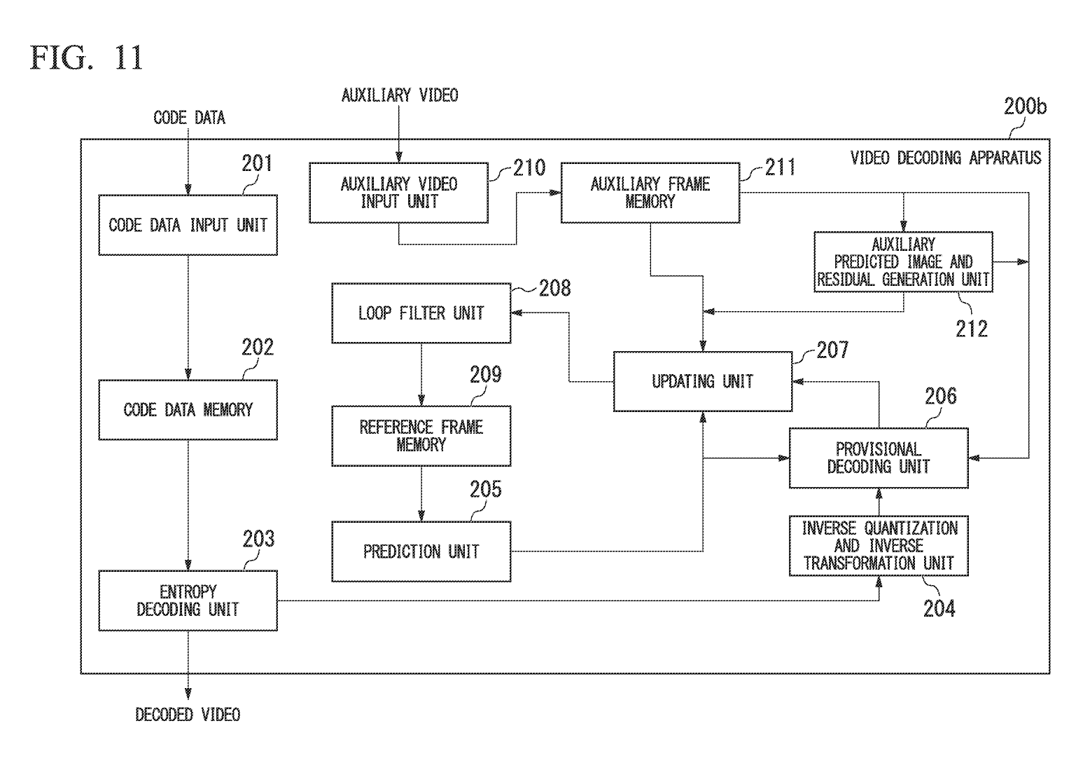

Below, a video decoding apparatus will be explained. FIG. 11 is a block diagram that shows the structure of the video decoding apparatus 200b according to the third embodiment of the present invention. In FIG. 11, parts identical to those in FIG. 7 are given identical reference numerals and explanations thereof are omitted here.

In comparison with the apparatus of FIG. 7, the apparatus of FIG. 11 has distinctive features of further providing an auxiliary video predicted image and residual generation unit 212.

The auxiliary video predicted image and residual generation unit 212 generates a predicted image and residual for the auxiliary video, where the generated information is referred to in the decoded image updating. Below, the predicted image and the residual (of the auxiliary video) for reference are respectively called an “auxiliary predicted image” and an “auxiliary prediction residual”.

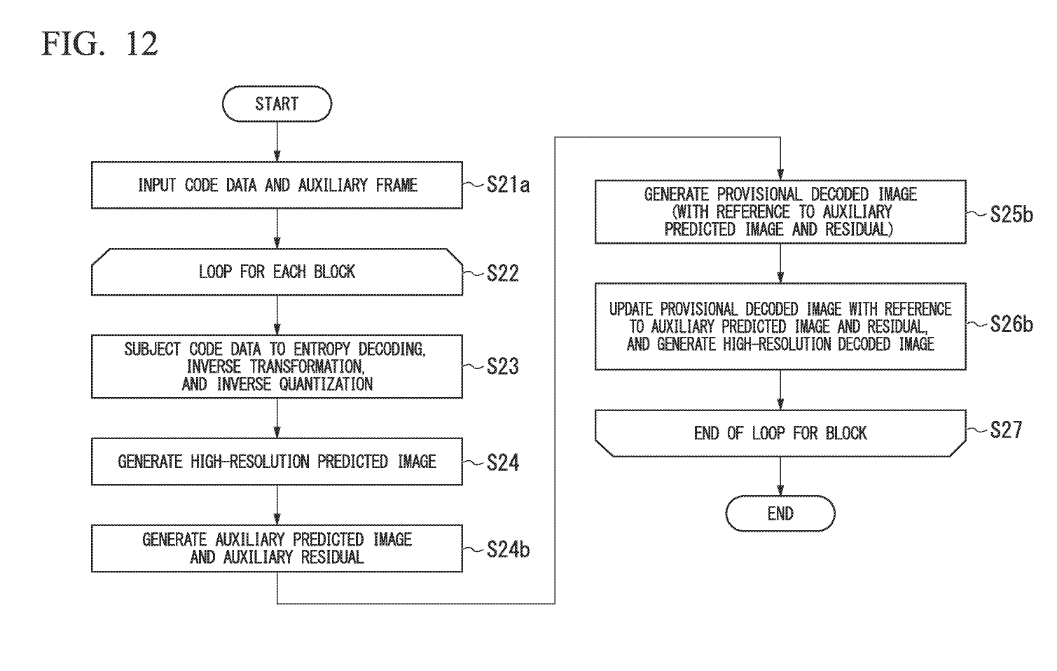

Next, in FIG. 12, the operation of the video decoding apparatus 200b shown in FIG. 11 will be explained. FIG. 12 is a flowchart that shows the operation of the video decoding apparatus 200b of FIG. 11.

FIG. 12 shows an operation in which auxiliary video and the predicted image and residual thereof are generated and utilized in the decoded image updating. In FIG. 12, steps identical to those in FIG. 8 are given identical step numbers and explanations thereof are omitted here.

First, the code data input unit 201 receives code data and stores the data in the code data memory 202. In parallel to this process, the auxiliary video input unit 210 receives an auxiliary video frame and stores the frame in the auxiliary frame memory 211 (see step S21a).

Here, some frames in the decoding target video have been previously decoded and are stored in the reference frame memory 209.

Here, steps S22 to S24 are executed in a manner similar to the corresponding steps in the flowchart of FIG. 8.

After generating the predicted image for the decoding target video, the auxiliary video predicted image and residual generation unit 212 generates the auxiliary predicted image and the auxiliary prediction residual, which are respectively a predicted image and a prediction residual for the auxiliary video (see step S24b).

Here, prediction information utilized to generate the auxiliary predicted image may be identical to the prediction information for the decoding target video or may be information obtained by a transformation as described above.

Next, the provisional decoding unit 108 generates a provisional decoded image by adding the high-resolution predicted image to corresponding pixels of the decoded low-resolution prediction residual (see step S25b).

If the positions of subsampled pixels have been determined utilizing the auxiliary predicted image, the auxiliary prediction residual, as described above, the corresponding positions (of the low-resolution prediction residual) in the high-resolution image may also be determined by a similar method.

Next, after the provisional decoding has been completed, the updating unit 207 performs updating of the provisional decoded image utilizing the provisional decoded image, the auxiliary predicted image, the auxiliary prediction residual, and other information so as to generate a high-resolution decoded image. The loop filter unit 208 then multiplies the generated high-resolution decoded image by a loop filter and stores the product as a reference block in the reference frame memory 209 (see step S26b).

Although the updating may be executing utilizing any method, if the employed method corresponds to the downsampling method employed in the relevant video encoding apparatus, a higher decoding performance can be obtained. The downsampling method and the decoded image updating method corresponding thereto can be performed as described above.

The multiplication utilizing the loop filter may not be performed if it is not necessary. However, in general video encoding, encoding noises are removed utilizing a deblocking filter or another filter. For this purpose, a filter utilized to remove degraded information due to RRU may be employed. In addition, such a loop filter may be adaptively generated similar to or in parallel with the decoded image updating.

Lastly, when all blocks have been processed (see step S27), the result thereof is output as a decoded frame.

In the operations shown in FIGS. 10 and 12, the execution order of the steps may be modified.

In the above-described first to third embodiments, RRU is applied to all blocks of the encoding target frame. However, RRU may be applied to part of the blocks. Furthermore, the blocks may have individual downsampling rates.

In such a case, information that indicates whether or not RRU can be applied or the downsampling rate may be encoded and included in additional information. In addition, the corresponding decoding apparatus may have a function of determining whether or not RRU can be applied or the downsampling rate. For example, whether or not RRU can be applied or the downsampling rate may be determined by referring to a predicted image.

If there is another video, image, or additional information to be referred to, the relevant determination may be executed with reference to such information. If the relevant information is encoded and transmitted, it is preferable to add a prevention or correction function of preventing a decoding disable state due to an encoding noise or transmission error.

Additionally, in the first to third embodiments, adaptive updating of decoded pixels is performed (i.e., the provisional decoded values of the provisional decoded image are updated) in every block. However, in order to reduce the amount of computation, the relevant updating may be omitted in each block which can acquire sufficient performance without performing the updating.

Furthermore, for any block which can acquire sufficient performance by performing interpolation utilizing a specific interpolation filter instead of the updating process, such a filter may be utilized. In this case, whether such a specific filter is utilized or the decoded image updating is performed may be switchably selected with reference to the relevant video or auxiliary information.

In addition, in the first to third embodiments, the decoded image updating is performed, in both the encoding apparatus and the decoding apparatus, inside the operation loop (i.e., for each block). However, the updating may be executed outside the loop if it is possible.

When the updating is performed for each block, the first row or first column may perform the relevant decoding with reference to pixels of a previously-decoded upper-left, upper, or left block of the present block.

Additionally, in the decoding of the first to third embodiments, the decoded image updating is executed with reference to a decoded signal obtained by the inverse transformation and inverse quantization of the code data. However, the decoded image updating may be executed with reference to quantized data (before the inverse quantization) or transformed data (before the transformation). In addition, code data is generated by subjecting the prediction residual of the encoding target video to transformation and quantization and then subjecting the obtained quantized data to the entropy encoding. However, encoding may be executed without performing the relevant transformation and quantization.

Although the first to third embodiments do not specifically distinguish luminance signals and color difference signals in the encoding target video from each other, they may be distinguished from each other.

For example, only the color difference signal is subjected to the downsampling and upsampling while the luminance signal that maintains an original high resolution is encoded. A reverse handling thereof is also possible.

The decoded image updating processes of the distinguished signals may be simultaneously or separately executed. For example, the decoded image updating process of a color difference signal may be executed with reference to a decoded image or other information obtained through the decoded image updating of a luminance signal. A reverse handling thereof is also possible.

In another example of the decoded image updating, a provisional decoded value is determined to be an initial value, and a final decoded value is estimated utilizing a probability density function that is defined in accordance with a predicted value, a variable based on any of various types of auxiliary information in the above-described examples, or a difference value, an average, or the like, thereof

An example of the probability density function is obtained based on a model (e.g., a model utilizing GMRF (Gaussian Markov Random Fields)) in which the occurrence probability of each pixel of the relevant image is determined depending on the values of peripheral pixels of the present pixel. With given xᵤ, which denotes the final decoded value to be computed, and Nᵤ, which denotes a set of variables, the occurrence probability is defined by the following Formula (1):

$$\begin{matrix}[ Formula 1 ] & \\ P ( {x}_{u} \vert {x}_{i} ∈ {N}_{u} ) = \frac{1}{\sqrt{2 πσ}} exp [ - \frac{1}{2 {σ}^{2}} \{ {x}_{u} - μ - {\sum }_{i ∈ {N}_{u}} {β}_{i} ( {x}_{u} - μ ) \} ] & ( 1 )\end{matrix}$$

If a set of the final decoded values to be computed for each block or a set of adjacent pixels is represented by “x={xᵤ}”, a pseudo likelihood PL thereof is represented as shown below, where each “xᵤ” is determined utilizing Formula (2) so that the pseudo likelihood PL is maximized.

$$\begin{matrix}[ Formula 2 ] & \\ PL ( x ) = {\prod }_{u} P ( {x}_{u} \vert {x}_{i} ∈ {N}_{u} ) & ( 2 )\end{matrix}$$

In the above Formula (1), μ is defined as an average of the decoded values, which may be an average over the entire image, over the entire block, or between adjacent pixels. Such an average may be computed in the video decoding apparatus by utilizing only subsampled pixels, or the video encoding apparatus may compute an average (over the entire image) utilizing a high-resolution image and encode the computed value so as to include the value, as additional information, in the relevant code data.

βᵢ denotes a control parameter and is generally determined in a manner such that the pseudo likelihood PL is maximized when the set of pixel values of the original image or an image, which has been encoded and then decoded by any method, is defined by “x={xᵤ}”, where the unit size to be processed is the entire image, each block, or each set of adjacent pixels.

That is, a single value alignment may be applied to the entire image, or individual values may be applied to different blocks or sets. In addition, appropriately predetermined values may be employed, or the values may be determined during the encoding and such values or additional information utilized to identify the values may be encoded and included in the corresponding code data. Furthermore, such values may be estimated for each image, or appropriate values may be estimated in advance utilizing learning data.

In the determination of xᵤ, an optimization problem may be solved utilizing any method. If the pseudo likelihood PL is simply maximized, xᵤ equals to μ. Therefore, another constraint condition may be employed. In an example of the condition, the density histogram of the entire image does not vary from the initial state thereof

In another example, when one of predetermined values, which has a high occurrence probability, is selected, the set of the predetermined values may be optimized. The set of the values may include an average of the decoded values of adjacent subsampled pixels or the decoded values of subsampled pixels which belong to the same group, or any other values may be employed.

In another example, when all pixels are individually updated, a value that produces a highest occurrence probability may be assigned to each pixel.

Additionally, priority may be established between the pixels, and the value determination may be executed according to the priority.

The probability density function may be defined in advance, or the probability density function may be locally modified for peripheral pixels in accordance with the updating of the decoded values.

Although the above-described example of the decoding method employs the GMRF, any probability density function may be employed, or an appropriate function may be estimated in advance utilizing learning data.

The parameters included in the relevant function may also be predetermined or estimated in advance. In addition, a probability value or a decoded value to be computed for the relevant function may be predetermined and referred to.

In addition, the code data alignment may be demultiplexed into auxiliary information code data and video code data, and auxiliary information may be obtained by decoding the auxiliary information code data.

As described above, the relevant image is provisionally decoded utilizing the prediction residual obtained by the downsampling, and the final decoded image is adaptively generated with reference to the provisional decoded image and certain information that correlates with the encoding target video. Therefore, degradation of the relevant quality or block distortion due to the upsampling for the prediction residual in RRU can be prevented and the final decoded image for every relevant resolution can have a desired quality.

Accordingly, the encoding efficiency can be improved utilizing an RRU mode while a desired subjective quality can be sufficiently secured.

The above-described operations of each video encoding apparatus and each video decoding apparatus may be implemented using a computer and a software program, where the program may be provided by storing it in a computer-readable storage medium, or through a network.

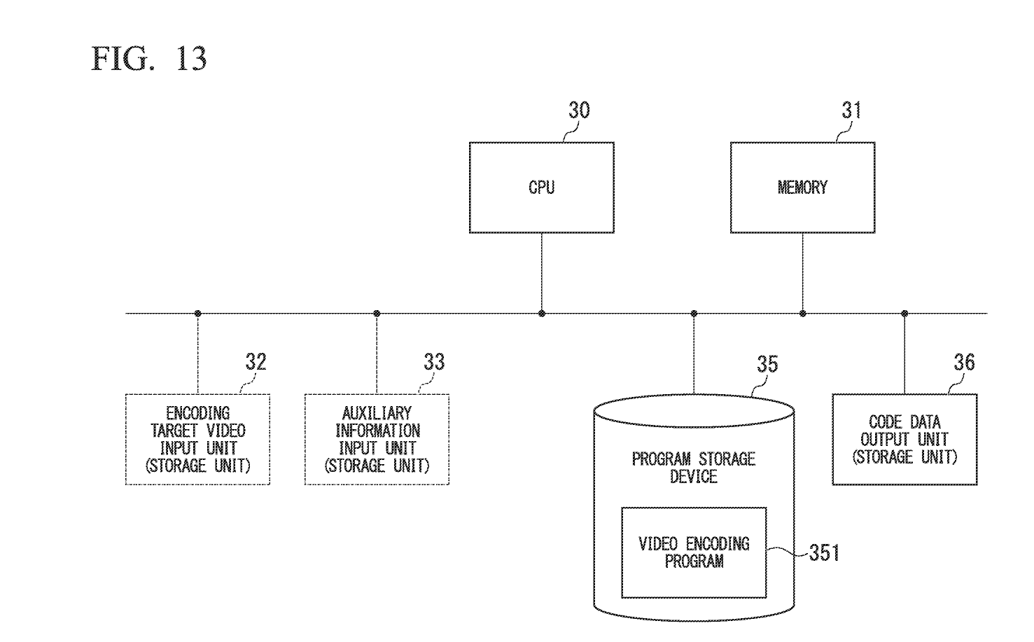

FIG. 13 shows an example of a hardware configuration of the video encoding apparatus formed using a computer and a software program.

In the relevant system, the following elements are connected via a bus:

(i) a CPU 30 that executes the relevant program;
(ii) a memory 31 (e.g RAM) that stores the program and data accessed by the CPU 30;
(iii) an encoding target video input unit 32 that makes a video signal of an encoding target from a camera or the like input into the video encoding apparatus and may be a storage unit (e.g., disk device) which stores the video signal;
(iv) a program storage device 35 that stores a video encoding program 351 which is a software program for making the CPU 30 execute the operation explained by referring to the drawings such as FIGS. 2, 6, and 10; and
(v) a code data output unit 36 that outputs coded data via a network or the like, where the coded data is generated by executing the video encoding program that is loaded on the memory 31 and executed by the CPU 30, and the output unit may be a storage unit (e.g., disk device) which stores the coded data.

In addition, if it is necessary to implement the encoding as explained in the second or third embodiment, the following unit may be further connected:

(vi) an auxiliary information input unit (storage unit) 33 that receives auxiliary information via a network or the like and may be a storage unit (e.g., disk device) which stores an auxiliary information signal.

Other hardware elements (not shown) are also provided so as to implement the relevant method, which are a code data storage unit, a reference frame storage unit, and the like. In addition, a video signal code data storage unit or a prediction information code data storage unit may be used.

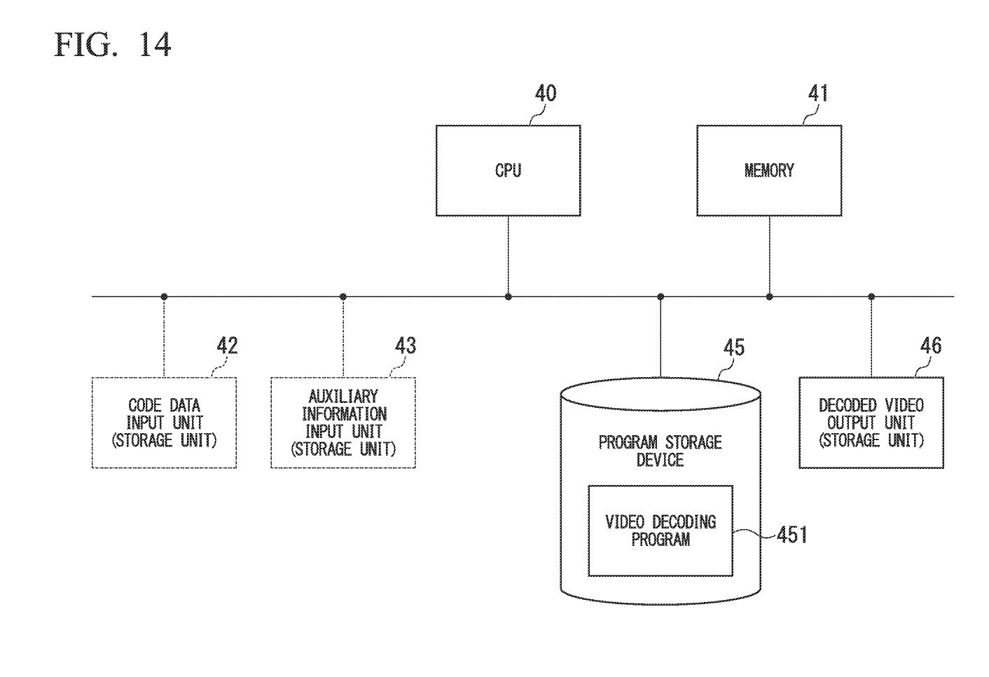

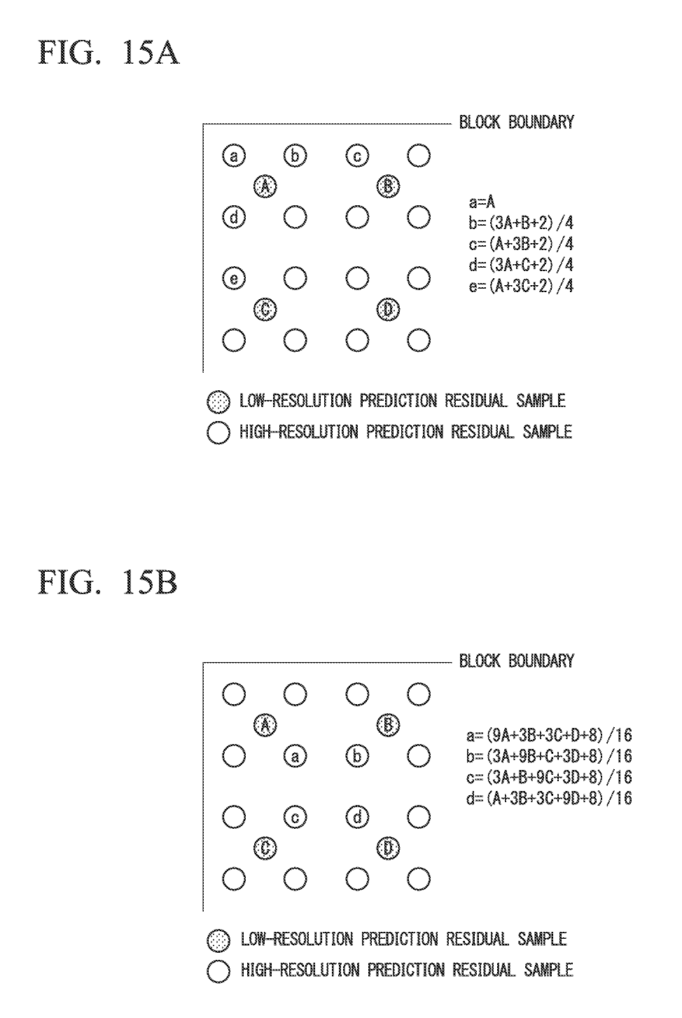

FIG. 14 shows an example of a hardware configuration of the video decoding apparatus formed using a computer and a software program.

In the relevant system, the following elements are connected via a bus:

(i) a CPU 40 that executes the relevant program;
(ii) a memory 41 (e.g., RAM) that stores the program and data accessed by the CPU 40;
(iii) a code data input unit 42 that makes code data obtained by a video encoding apparatus (which performs a method according to the present invention) input into the video decoding apparatus, where the input unit may be a storage unit (e.g., disk device) which stores the code data;
(iv) a program storage device 45 that stores a video decoding program 451 which is a software program for making the CPU 40 execute the operation explained by referring to the drawings such as FIGS. 4, 8, and 12; and
(v) a decoded video data output unit 46 that outputs decoded video to a reproduction device or the like, where the decoded video is obtained by executing the video decoding program that is loaded on the memory 41 and executed by the CPU 40.

In addition, if it is necessary to implement the decoding as explained in the second or third embodiment, the following unit may be further connected:

(iv) an auxiliary information input unit (storage unit) 43 that receives auxiliary information via a network or the like and may be a storage unit (e.g., disk device) which stores an auxiliary information signal.

Other hardware elements (not shown) are also provided so as to implement the relevant method, which include a reference frame storage unit. In addition, a video signal code data storage unit or a prediction information code data storage unit may be used.

A program for executing the functions of the video encoding apparatus as shown in FIG. 1, 5, or 9, or the video decoding apparatus as shown in FIG. 3, 7, 11 may be stored in a computer readable storage medium, and the program stored in the storage medium may be loaded and executed on a computer system, so as to perform the relevant video encoding or decoding operation.

Here, the computer system has hardware resources which may include an OS and peripheral devices. The computer system also has a WWW system that provides a homepage service (or viewable) environment.

The above computer readable storage medium is a storage device, for example, a portable medium such as a flexible disk, a magneto optical disk, a ROM, or a CD-ROM, or a memory device such as a hard disk built in a computer system.

The computer readable storage medium also includes a device for temporarily storing the program, such as a volatile memory (RAM) in a computer system which functions as a server or client and receives the program via a network (e.g., the Internet) or a communication line (e.g., a telephone line).

The above program, stored in a memory device or the like of a computer system, may be transmitted via a transmission medium or by using transmitted waves passing through a transmission medium to another computer system. The transmission medium for transmitting the program has a function of transmitting data, and is, for example, a (communication) network such as the Internet or a communication line such (e.g., a telephone line).

In addition, the program may execute part of the above-explained functions.

The program may also be a “differential” program so that the above-described functions can be executed by a combination program of the differential program and an existing program which has already been stored in the relevant computer system.

While the embodiments of the present invention have been described and shown above, it should be understood that these are exemplary embodiments of the invention and are not to be considered as limiting. Additions, omissions, substitutions, and other modifications can be made without departing from the technical concept and scope of the present invention.

### INDUSTRIAL APPLICABILITY

The present invention can be applied to a purpose that essentially requires a condition such that degradation in quality or block distortion of the decoded image due to the upsampling for the prediction residual in RRU can be prevented and a final decoded image for every relevant resolution can have a desired quality.

### REFERENCE SYMBOLS

100, 100a, 100b video encoding apparatus
101 encoding target video input unit
102 input frame memory
103 prediction unit
104 subtraction unit
105 residual downsampling unit
106 transformation and quantization unit
107 inverse quantization and inverse transformation unit
108 provisional decoding unit
109 updating unit
110 loop filter unit
111 reference frame memory
112 entropy encoding unit
113 auxiliary video input unit
114 auxiliary frame memory
115 auxiliary predicted image and residual generation unit
200, 200a, 200b video decoding apparatus
201 code data input unit
202 code data memory
203 entropy decoding unit
204 inverse quantization and inverse transformation unit
205 prediction unit
206 provisional decoding unit
207 updating unit
208 loop filter unit
209 reference frame memory
210 auxiliary video input unit
211 auxiliary frame memory
212 auxiliary predicted image and residual generation unit

1. A video decoding method utilized when decoding code data of a video, wherein each frame that forms the video is divided into a plurality of processing regions, each processing region is subjected to predictive decoding, and the method comprises:
a provisional decoding step that generates a provisional decoded image obtained by provisional image decoding utilizing a low-resolution prediction residual; and
a decoded image generation step that generates a final decoded image by updating decoded values of the provisional decoded image.

2. The video decoding method in accordance with claim 1, further comprising:
a sampling and interpolation step that generates an interpolated prediction residual by means of an interpolation process which executes sampling and interpolation utilizing pixels for which the low-resolution prediction residual was computed,
wherein the provisional decoding step generates the provisional decoded image based on the interpolated prediction residual.

3. The video decoding method in accordance with claim 2, wherein:
the sampling and interpolation step executes the interpolation process with reference to auxiliary information that correlates with the video.

4. The video decoding method in accordance with claim 2, wherein:
the decoded image generation step generates the final decoded image with reference to auxiliary information that correlates with the video.

5. The video decoding method in accordance with claim 1, further comprising:
a residual associated pixel determination step that determines a positional relationship between each pixel of the low-resolution prediction residual and a corresponding pixel of the provisional decoded image, wherein:
the provisional decoding step generates the provisional decoded image by performing decoding of original pixels of the provisional decoded image, which correspond to the pixels of the low-resolution prediction residual, based on the positional relationship; and
the decoded image generation step generates the final decoded image using the decoded values of the pixels of the provisional decoded image, which correspond to the pixels of the low-resolution prediction residual, so as to update the decoded values of the other pixels in the provisional decoded image.

6. The video decoding method in accordance with claim 5, wherein:
the residual associated pixel determination step determines a predetermined relationship to be the positional relationship.

7. The video decoding method in accordance with claim 5, wherein:
the residual associated pixel determination step adaptively determines the positional relationship.

8. The video decoding method in accordance with claim 7, wherein:
the residual associated pixel determination step adaptively determines the positional relationship with reference to auxiliary information that correlates with the video.

9. The video decoding method in accordance with claim 5, wherein:
the decoded image generation step generates the final decoded image by further referring to auxiliary information that correlates with the video.

10. The video decoding method in accordance with claim 5, further comprising:
a sampling and interpolation step that generates an interpolated prediction residual by means of an interpolation process which executes sampling and interpolation utilizing pixels for which the low-resolution prediction residual was computed, wherein:
the provisional decoding step generates the provisional decoded image by performing:
the decoding of the original pixels of the provisional decoded image, which correspond to the pixels of the low-resolution prediction residual, based on the positional relationship, and
decoding of the other original pixels of the provisional decoded image, which do not correspond to the pixels of the low-resolution prediction residual, based on the interpolated prediction residual; and
the decoded image generation step generates the final decoded image using the decoded values of the pixels of the provisional decoded image, which correspond to the pixels of the low-resolution prediction residual, so as to update the decoded values of the other pixels in the provisional decoded image.

11. The video decoding method in accordance with claim 10, wherein:
the residual associated pixel determination step determines a predetermined relationship to be the positional relationship.

12. The video decoding method in accordance with claim 10, wherein:
the residual associated pixel determination step adaptively determines the positional relationship.

13. The video decoding method in accordance with claim 12, wherein:
the residual associated pixel determination step adaptively determines the positional relationship with reference to auxiliary information that correlates with the video.

14. The video decoding method in accordance with claim 10, wherein:
the decoded image generation step generates the final decoded image by further referring to auxiliary information that correlates with the video.

15. The video decoding method in accordance with any one of claims 3, 4, 8, 9, 13, and 14, wherein:
the auxiliary information is a predicted image for the video.

16. The video decoding method in accordance with any one of claims 3, 4, 8, 9, 13, and 14, wherein:
the auxiliary information is part of components of a signal that forms the video.

17. The video decoding method in accordance with any one of claims 3, 4, 8, 9, 13, and 14, wherein:
the auxiliary information is an auxiliary video that correlates with the video.

18. The video decoding method in accordance with claim 17, wherein:
the auxiliary video is another video that captures a scene identical to that captured by the above video.

19. The video decoding method in accordance with claim 17, wherein:
when the video is a video from a viewpoint among a multi-viewpoint video, the auxiliary video may be a video from another viewpoint.

20. The video decoding method in accordance with claim 17, wherein:
the auxiliary video is a depth map that corresponds to the above video.

21. The video decoding method in accordance with claim 17, wherein:
when the video is a depth map, the auxiliary video is a texture that corresponds to the depth map.

22. The video decoding method in accordance with any one of claims 3, 4, 8, 9, 13, and 14, wherein:
the auxiliary information is an auxiliary video predicted image generated from an auxiliary video, that correlates with the above video, based on prediction information for this video; and
the method further comprises:
an auxiliary video predicted image generation step that generates the auxiliary video predicted image from the auxiliary video, based on the prediction information for the video.

23. The video decoding method in accordance with claim 22, wherein:
the auxiliary information is an auxiliary video prediction residual generated from the auxiliary video and the auxiliary video predicted image; and
the method further comprises:
an auxiliary video prediction residual generation step that generates the auxiliary video prediction residual from the auxiliary video and the auxiliary video predicted image.

24. The video decoding method in accordance with any one of claims 3, 4, 8, 9, 13, and 14, wherein:
a demultiplexing step that demultiplexes the code data into auxiliary information code data and video code data; and
an auxiliary information decoding step that decodes the auxiliary information code data to generate the auxiliary information

25. A video encoding method utilized when dividing each frame that forms a video into a plurality of processing regions and subjecting each processing region to predictive encoding in which a high-resolution prediction residual is subjected to downsampling to generate a low-resolution prediction residual, the method comprising:
a subsampling step that generates a subsampled prediction residual by means of a subsampling process which subjects only part of pixels of the high-resolution prediction residual to sampling; and
a residual downsampling step that determines the subsampled prediction residual to be the low-resolution prediction residual.

26. The video encoding method in accordance with claim 25, wherein:
in the subsampling step, positions of the pixels subjected to the sampling are predetermined.

27. The video encoding method in accordance with claim 25, wherein:
the subsampling step adaptively determines the pixels subjected to the sampling.

28. The video encoding method in accordance with claim 27, wherein:
the subsampling step adaptively determines the pixels subjected to the sampling with reference to auxiliary information that correlates with the video.

29. The video encoding method in accordance with claim 25, further comprising:
a sampling and interpolation step that generates an interpolated prediction residual by means of an interpolation process which executes sampling and interpolation for the pixels of the high-resolution prediction residual,
wherein the residual downsampling step generates the low-resolution prediction residual from the subsampled prediction residual and the interpolated prediction residual.

30. The video encoding method in accordance with claim 29, wherein:
the residual downsampling step generates the low-resolution prediction residual by applying the subsampled prediction residual to predetermined positions of the low-resolution prediction residual and applying the interpolated prediction residual to the other positions of the low-resolution prediction residual.

31. The video encoding method in accordance with claim 29, wherein:
the residual downsampling step generates the low-resolution prediction residual from the subsampled prediction residual and the interpolated prediction residual with reference to auxiliary information that correlates with the video.

32. The video encoding method in accordance with claim 28 or 31, wherein:
the auxiliary information is a predicted image for the video.

33. The video encoding method in accordance with claim 28 or 31, wherein:
the auxiliary information is part of components of a signal that forms the video.

34. The video encoding method in accordance with claim 28 or 31, wherein:
the auxiliary information is an auxiliary video that correlates with the video.

35. The video encoding method in accordance with claim 34, wherein:
the auxiliary video is another video that captures a scene identical to that captured by the above video.

36. The video encoding method in accordance with claim 34, wherein:
when the video is a video from a viewpoint among a multi-viewpoint video, the auxiliary video is a video from another viewpoint.

37. The video encoding method in accordance with claim 34, wherein:
the auxiliary video is a depth map that corresponds to the above video.

38. The video encoding method in accordance with claim 34, wherein:
when the video is a depth map, the auxiliary video is a texture that corresponds to the depth map.

39. The video encoding method in accordance with claim 28 or 31, wherein:
the auxiliary information is an auxiliary video predicted image generated from an auxiliary video, that correlates with the above video, based on prediction information for this video; and
the method further comprises:
an auxiliary video predicted image generation step that generates the auxiliary video predicted image from the auxiliary video, based on the prediction information for the video.

40. The video encoding method in accordance with claim 39, wherein:
the auxiliary information is an auxiliary video prediction residual generated from the auxiliary video and the auxiliary video predicted image; and
the method further comprises:
an auxiliary video prediction residual generation step that generates the auxiliary video prediction residual from the auxiliary video and the auxiliary video predicted image.

41. The video encoding method in accordance with claim 28 or 31, further comprising:
an auxiliary information encoding step that encodes the auxiliary information to generate auxiliary information code data; and
a multiplexing step that generates code data in which the auxiliary information code data is multiplexed with video code data.

42. A video decoding apparatus utilized when decoding code data of a video, wherein each frame that forms the video is divided into a plurality of processing regions, each processing region is subjected to predictive decoding, and the apparatus comprises:
a provisional decoding device that generates a provisional decoded image obtained by provisional image decoding utilizing a low-resolution prediction residual; and
a decoded image generation device that generates a final decoded image by updating decoded values of the provisional decoded image.

43. A video encoding apparatus utilized when dividing each frame that forms a video into a plurality of processing regions and subjecting each processing region to predictive encoding in which a high-resolution prediction residual is subjected to downsampling to generate a low-resolution prediction residual, the apparatus comprising:
a subsampling device that generates a subsampled prediction residual by means of a subsampling process which subjects only part of pixels of the high-resolution prediction residual to sampling; and
a residual downsampling device that determines the subsampled prediction residual to the low-resolution prediction residual.

44. A video decoding program by which a computer executes the steps in the video decoding method in accordance with claim 1.

45. A video encoding program by which a computer executes the steps in the video encoding method in accordance with claim 25.

46. A computer-readable storage medium which stores a video decoding program by which a computer executes the steps in the video decoding method in accordance with claim 1.

47. A computer-readable storage medium which stores a video encoding program by which a computer executes the steps in the video encoding method in accordance with claim 25.
